(19) United States
(12) Patent Application Publication
(10) Pub. No.: US 2007/0005654 A1
(43) Pub. Date: Jan. 4, 2007

(54) Systems and methods for analyzing relationships between entities

(76) Inventors: Avichai Schachar, Toronto (CA); Simon Brajtman, Toronto (CA); Aleksander Zivkovic, Willowdale (CA)

Correspondence Address: STOEL RIVES LLP - SLC, 201 SOUTH MAIN STREET, ONE UTAH CENTER, SALT LAKE CITY, UT, 84111, US

(21) Appl. No.: 11/438,674

(22) Filed: May 22, 2006

Related U.S. Application Data
(60) Provisional application No. 60/683,332, filed on May 20, 2005.

(51) Int. Cl. G06F 17/00

(52) U.S. Cl. 707/104.1

(57) ABSTRACT

An information hierarchy is defined to allow automatic collection, monitoring and categorization of information about a subject and the subject's social network. The subject may be, for example, an individual or an organization. The information is automatically collected from a broad range of sources and automatically monitored to generate targeted alerts. The information hierarchy includes an intelligence task that defines an objective for collecting and analyzing the information. The hierarchy also includes indicators corresponding to the intelligence task and triggers corresponding to the indicators. The triggers, when detected, indicate the likely occurrence of one or more of the indicators. Intelligent agents collect the information so it can be analyzed with respect to the information hierarchy. The analysis includes the discovery of direct and indirect relationships between entities. Thus, users can review and predict underlying threats imposed by the relationships.

### RELATED APPLICATIONS

This application claims the benefit under 35 U.S.C. § 119(e) of U.S. Provisional Application No. 60/683,332, filed May 20, 2005, which is hereby incorporated by reference herein in its entirety.

### TECHNICAL FIELD

This disclosure relates generally to automated monitoring of information collected from a broad range of sources. More specifically, this disclosure relates to systems and methods for discovering, analyzing, and visualizing relationships between entities.

### BRIEF DESCRIPTION OF THE DRAWINGS

Non-limiting and non-exhaustive embodiments are described herein, including various embodiments disclosed with reference to the figures, in which:

FIG. 1 is a block diagram of an information hierarchy according to one embodiment;

FIG. 2 is a block diagram of a system for collecting information and analyzing the behavior of a social network according to one embodiment;

FIG. 3 is a general representation of a user interface for analyzing relationships between entities according to one embodiment;

FIG. 4 is a flow chart of a method for discovering and predicting behavior in a social network according to one embodiment;

FIGS. 5A-5C are partial link charts illustrating relationships between entities in a social network;

FIG. 6 is a block diagram of an exemplary server for collecting and analyzing information related to a subject and the subject's social network according to one embodiment;

FIGS. 7A-7F are block diagrams of various submodules for a workflow manager shown in FIG. 6;

FIG. 8 is a general representation of a user interface that displays a user's “daily profile” of current alerts and daily collection tasks;

FIG. 9 is a general representation of a user interface for an alert page that displays available alert information;

FIG. 10 is a general representation of a user interface for entering and editing mission statements and objectives;

FIG. 11 is a general representation of a user interface for entering and editing multiple intelligence tasks;

FIG. 12 is a general representation of a user interface for entering and editing indicators;

FIG. 13 is a general representation of a user interface for a trigger administration table;

FIG. 14 illustrates the user interface shown in FIG. 12 during a setup process for creating a collection task;

FIG. 15 is a general representation of a user interface illustrating a search using triggers to support simple Boolean operations;

FIG. 16 is a general representation of a user interface for scheduling recurring searches or jobs;

FIG. 17 is a general representation of a user interface for specifying a database connection string by selecting options or entering data in a plurality of data entry fields;

FIG. 18 is a general representation of a user interface for mapping fields into an i-sight database;

FIG. 19 is a general representation of a user interface for collecting and analyzing information;

FIG. 20 is a general representation of a user interface corresponding to an item page showing collected information items;

FIG. 21 is general representation of a user interface for adding information items;

FIGS. 22A-22E are general representations of a user interface for displaying and analyzing subjects;

FIG. 23 is a general representation of a user interface for displaying a link graph of a target subject and a plurality of associated subjects;

FIG. 24 is a general representation of a user interface for performing a “basic” search;

FIG. 25 is a general representation of a user interface for accessing search histories;

FIG. 26 is a general representation of a user interface for displaying draft assessment information;

FIG. 27 is a general representation of a user interface for accessing predetermined reports;

FIG. 28 is a general representation of a user interface that allows a user to specify a range of dates for the assessments shown in FIG. 26;

FIG. 29 is an example intelligence assessment report;

FIG. 30 is an example information item report;

FIG. 31 is a general representation of a user interface that allows a user to generate a report for a selected subject;

FIG. 32 is a an example subject report;

FIG. 33 is a general representation of a user interface that allows a user to select an indicator from an indicator list;

FIG. 34 is an example indicator report;

FIG. 35 illustrates an example format of an ad-hoc report; and

FIG. 36 is an example official report.

### DETAILED DESCRIPTION

The embodiments of the disclosure will be best understood by reference to the drawings, wherein like elements are designated by like numerals throughout. In the following description, numerous specific details of programming, software modules, user selections, network transactions, database queries, database structures, and other details are provided for a thorough understanding of the embodiments described herein. However, those of skill in the art will recognize that one or more of the specific details may be omitted, or other methods, components, or materials may be used.

In some cases, well-known structures, materials, or operations are not shown or described in detail. Furthermore, the described features, structures, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, or the like that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices.

Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

I. Information Hierarchy

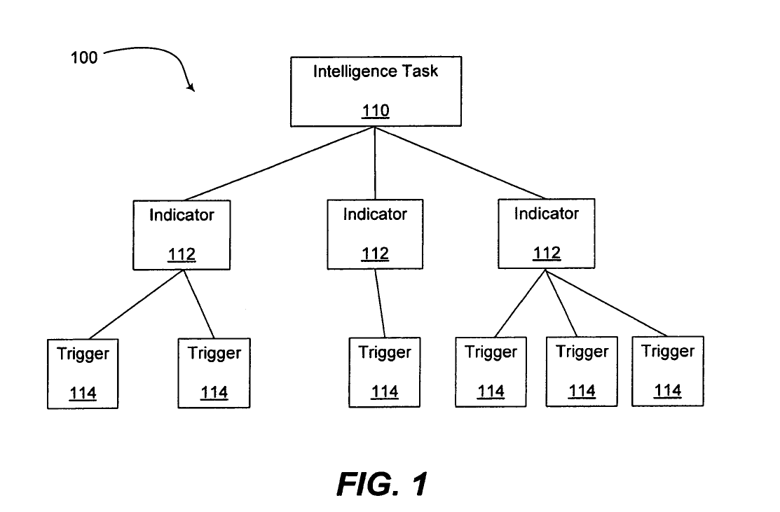

FIG. 1 is a block diagram of an information hierarchy 100 according to one embodiment. Systems and methods described herein use the information hierarchy 100 to automatically collect, monitor and categorize information about a subject (e.g., an individual or an organization) and the subject's social network. The information is automatically collected from a broad range of sources and automatically monitored to generate targeted alerts. As discussed in further detail below, information searches integrate internal organizational databases and external sources such as databases accessible through the Internet. The integration with internal databases enables controlled access and sharing of previously inaccessible information.

The collected information is analyzed with respect to the information hierarchy 100 to discover direct and indirect relationships between entities and underlying threats imposed by the relationships. The large amount of collected information may be disparate, or at least may initially appear to be disparate. However, according to the embodiments disclosed herein, users have an enhanced ability to evaluate and predict activities by related entities at an early stage and to take preemptive action, if desired. Entities and/or relationships of concern are automatically flagged to facilitate further due diligence and assessment. To aid in the analysis, links, charts and flexible reports are automatically generated in real time. Thus, the speed and productivity of intelligence gathering and analysis are increased.

The information hierarchy 100 includes an intelligence task 110, one or more indicators 112 (three shown) related to the intelligence task 110, and one or more triggers 114 (six shown) related to each indicator 112. By way of example, and not by limitation, Table 1 below shows one possible definition of an intelligence task 110, indicators 112, and triggers 114.

TABLE 1

| Intelligence | Detection of Eastern European organized crime involvement in the | | |
|---|---|---|---|
| Task | Canadian capital markets | | |
| | Indicator | Targeted Russian businessmen entering into Canada | |
| | | Trigger | Semion Moghilevich |
| | Indicator | Officers, directors or major shareholders of Canadian | |
| | | companies having Eastern European family names | |
| | | Trigger | Moghilevich, Boroz, Berezovsky, Abramovich |
| | Indicator | Russian companies setting up North American subsidiaries | |
| | | Trigger | LukeOil, Sibneft, Millhouse Capital, |
| | | | Kogalymneftgaz, Russian Aluminum |
| | Indicator | Public companies managed by offshore entities with | |
| | | Russian directors | |
| | | Trigger | Cayman, BVI, Belize, *vich, *vic, *ski, *sky |

The intelligence task 110 defines a user's objective for gathering and analyzing information related to a subject. The intelligence task 110 is related to a specific activity of a known subject, and subsequent collection and analysis of information is performed within the context of the intelligence task 110. In the example shown in Table 1, the intelligence task 110 is defined as the detection of Eastern European organized crime involvement in the Canadian capital markets. This may, for example, be an objective of a particular Canadian crime enforcement agency. An artisan will recognize from the disclosure herein that such an agency could have additional objectives that could also be defined as additional intelligence tasks, if desired.

Individuals, corporations, law enforcement agencies, governments, and other groups around the world may take proactive measures to gather and analyze information about other entities. For example, certain law enforcement agencies use public, private, and/or classified information available from local databases or from networks such as the Internet to combat criminal activities such as money laundering, stock fraud, market manipulation, terrorist financing, terrorism, organized crime, and other financial or non-financial crimes. Further, recent legislation (e.g., the U.S. Patriot Act and Sarbanes-Oxley Act) places the responsibility of proactive screening of clients and the development of an effective compliance program on financial institutions and other corporations. The impact of non-compliance can be severe. Thus, many government and/or private groups may have objectives similar to the intelligence task 110 listed in Table 1 for their corresponding jurisdictions.

The indicators 112 are conditions that, when detected, indicate an increased probability that the related intelligence task 110 will be accomplished. The triggers 114 are conditions that, when detected alone or in combination with other triggers 114, indicate the occurrence or likely occurrence of a related indicator 112. For example, Table 1 defines four indicators 112 that are useful for detecting the involvement of Eastern European organized crime in the Canadian capital markets. One indicator 112 includes the occurrence of targeted Russian businessmen entering into Canada. Such an occurrence may be determined, for example, by searching for and detecting a trigger 114 that includes a targeted individual's name in the context of entering into or being in Canada. In the example shown in Table 1, the targeted individual is named “Semion Moghilevich.”

Another indicator 112 includes the occurrence of officers, directors or major shareholders of Canadian companies having Eastern European family names. A related trigger 114 may include detecting names such as “Moghilevich,” “Boroz,” “Berezovsky,” “Abramovich” or other Eastern European names in the context of Canadian company ownership or control. Another indicator 112 includes Russian companies setting up North American subsidiaries, which may be determined by detecting a trigger 114 that includes one or more suspected Russian company name such as “LukeOil,” “Sibneft,” “Millhouse Capital,” “Kogalymneftgaz,” “Russian Aluminum,” or the like.

Yet another indicator 112 useful for detecting the involvement of Eastern European organized crime in the Canadian capital markets is the occurrence of public companies managed by offshore entities with Russian directors. A trigger 114 for such an occurrence includes the detection of an offshore country where suspected management may occur. As shown in Table 1, suspected countries may include, for example, the Cayman Islands, the British Virgin Islands, and Belize. The trigger 114 may also include a Russian name or a partial Russian name in the context of a public company managed by an offshore entity. Partial Russian names may include, for example, “*vich,” “*vic,” “*ski,” or “*sky,” where “*” is a wild card indicating where other characters in the name may appear.

II. System

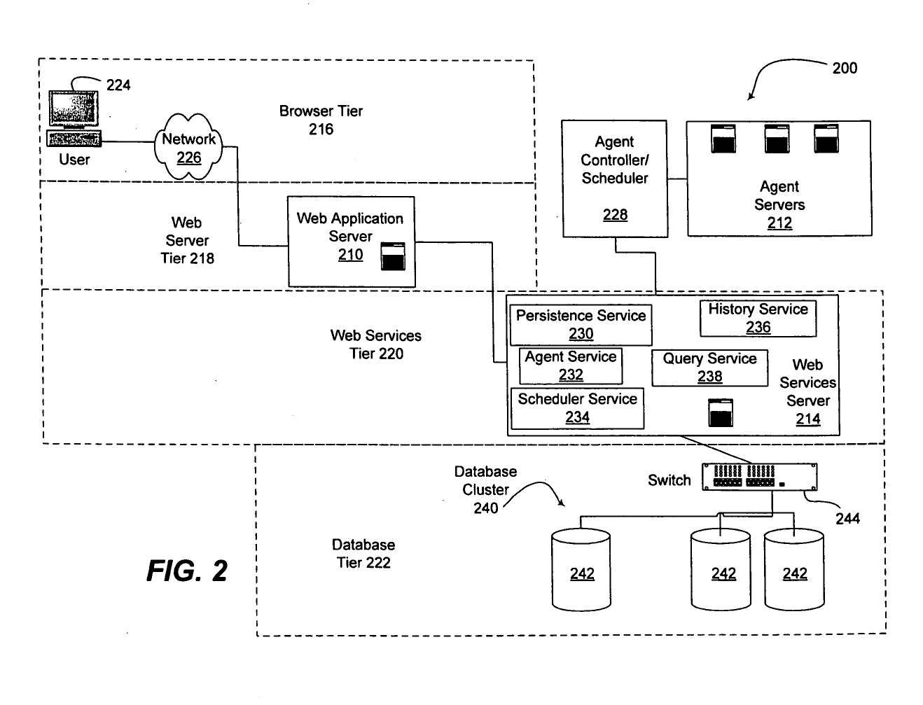

FIG. 2 is a block diagram of a system 200 for collecting information and analyzing the behavior of a social network according to one embodiment. The system 200 may be operable on one or more servers 210, 212, 214 that may include computer readable instructions. While an artisan will recognize that one or more of the servers 210, 212, 214 may be combined on a single computer or server, using an architecture as illustrated in FIG. 2 that distributes functionality onto different servers 210, 212, 214, or even different networks improves security and provides for interchangeability of architectural layers.

In the embodiment illustrated in FIG. 2, the system 200 includes an application architecture that distributes the system's functionality among the system's components and/or architectural layers or “tiers.” For example, the system 200 includes a browser tier 216, a web application server tier 218, a web services tier 220, and a database tier 222.

The browser tier 216 provides system access to a user 224 through a network 226. The user 224 may communicate with the system 200 using, for example, a computer comprising any microprocessor controlled device that permits access to the network 226, including terminal devices, such as personal computers, workstations, servers, mini-computers, hand-held computers, main-frame computers, laptop computers, mobile computers, set top boxes for televisions, combinations thereof, or the like. Such computers may further include input devices such as a keyboard or a mouse, and output devices such as a computer screen, a printer or a speaker. The network 226 may include the Internet or the World Wide Web, or an intranet such as a local area network (LAN) or wide area network (WAN), or any other network of communicating computerized devices.

The web server tier 218 includes a web application server 210 configured to execute computer readable instructions as disclosed herein. In one embodiment, the web server tier 218 is based on asp.net web development technology for a .net platform. However, an artisan will recognize from the disclosure herein that other web development technologies can also be used. The web application server 210 hosts one or more web pages that the user 224 can access through the network 226 to configure a collection task or job for collecting information and analyzing the information in the context of the information hierarchy 100 discussed above. The web application server 210 allows the user 224 to specify which information sources to search in order to collect information related to a subject. The web application server 210 also allows the user 224 to define the information hierarchy 100 and to set search parameters based on the triggers 114.

The system 200 also includes an agent controller/scheduler 228 configured to control the execution of agent jobs handled by the agent servers 212 (three shown) and to schedule agent activities. It should be noted that the agent controller/scheduler 228 and the agent servers 212 are not part of the tiers 216, 218, 220, 222. The agent jobs include software or computer readable instructions to collect information from one or more sources based on the parameters set by the user 224. The agent jobs also report back a status of the collection process and/or a payload of collected data. The agent jobs provide information from which decisions can be derived within the context of the information hierarchy 100. An agent job specification (discussed below) describes the steps that the agent servers 212 take when collecting data from a specified source.

As discussed below, the agent servers 212 collect the requested information from the specified sources through the network 226 and store the collected information in a database cluster 240 in the database tier 222. In one embodiment, the full text or a substantial portion of the collected information in the database cluster 240 is indexed. The web services tier 220 includes a web services server 214 that scans the collected information in the database cluster 240 for specified triggers 114. If a trigger 114 is detected in the database cluster 240, an alert is generated and the user 224 is notified of the alert.

In one embodiment, cross-organization collaboration enables separate and/or geographically remote users 224 to share information in real time. By applying custom access levels to each piece of information within the system 200 and encrypting communication channels, a user 224 can allow strictly regulated access to other users 224 outside of their organization with whom they wish to share information. In one such embodiment, three access levels called “shared,” “hit only,” and “silent hit” are used.

For example, company A and company B may desire to exchange information with each other through an encrypted communication channel. After collecting information on a particular subject (e.g., an individual or an organization), company A can tag the information related to the subject as shared, hit only, or silent hit. If the information is tagged as “shared,” a search by company B for information related to the subject will return a positive hit notification from company A. Company B will also be granted access to the collected information.

If the information is tagged as “hit only,” company B would instead receive only a positive hit notification from company A. The hit notification would indicate that company A has information relevant to the query that cannot be directly shared with company B due to its sensitivity. Company B may then contact company B or another party for further discussion regarding the sensitive information. Company A would also receive notification that company B had expressed interest in the particular subject. Thus, company A could decide if and when to contact company B to discuss providing the information.

For material that requires a very high degree of confidentiality (e.g., due to the source from which it originated), users can tag items such that no notification at all is returned to a user 224 performing a search. Thus, if company A tags the information regarding the particular subject as a “silent hit,” a search by company B for the subject would not return any results from company A. To company B, it would appear as if company A did not have any relevant information to be offered. Company A would receive notification that company B is interested in the particular subject and could discreetly decide whether or not to contact company B regarding the confidential information.

Returning to FIG. 2, the agent controller/scheduler 228 receives agent job requests from the web services tier 220 and activates appropriate agents with appropriate parameters. The agent controller/scheduler 228 also reports on the progress of agent jobs and provides the payload of the agent jobs to a persistence service module 230 in the web services tier 220. In one embodiment, the payload includes an original response from the source including any markup and images (e.g., a complete web grab). The agent controller/scheduler 228 also generates a listing of images with image sizes and dates for the agent job and provides the listing to the persistence service module 230. In one embodiment, the persistence service module 230 uses the listing of images as a manifest so it can save the downloaded images and content.

In addition, or in another embodiment, the agent controller/scheduler 228 processes the payload to remove any markup (e.g., hypertext). For example, for PDF, Word or Excel documents, the agent controller/scheduler 228 converts the markup to text. For HTML, for example, the agent controller/scheduler 228 simply removes HTML markup. The agent controller/scheduler 228 then provides the processed text of the agent jobs to the persistence service module 230.

The agent controller/scheduler 228 is further configured to provide communication between the agent servers 212 and the rest of the system 200. In one embodiment, the agent servers 212 do not communicate directly with the web application server tier 218 or the web services tier 220. Thus, the number of communication protocols used by the agent servers 212 is reduced. Further, isolating the agent servers 212 as proxies increases security by eliminating or reducing traceability of information requested and/or collected through the agent servers 212.

The agent controller/scheduler 228 handles communication between the agent servers 212 and the rest of the system 200 by providing requests for agent jobs (discussed below) to the agent servers 212, providing progress updates of the agent jobs from the agent servers 212, and providing collected information or payloads of the agent jobs from the agent servers 212. In one embodiment, the agent controller/scheduler 228 communicates with the agent servers 212 by invoking appropriate functions on objects in dynamic link libraries (DLLs) (e.g., for Windows) or shared objects (e.g., for Unix/Linux).

The agent controller/scheduler 228 also schedules or triggers agent jobs at pre-specified times. As discussed below, agent job specifications can include start times and dates for agent jobs to be triggered. The agent controller/scheduler 228 is configured to start the agents at the specified times.

The agent servers 212 support various protocols, authentication methods and scripts to perform “hidden web” information retrievals. The agent servers 212 may use different objects for different protocols (e.g., different objects for http and https). While three agent servers 212 are shown, an artisan will recognize from the disclosure herein that any number of agent servers 212 can be used for a particular application. Further, the agent servers 212 can be combined with one or more of the other servers 210, 214.

The agent servers 212 are configured to receive an agent job specification from the agent controller/scheduler 228. As discussed below, the agent job specification may include a date that indicates when the corresponding agent job was last executed. The agent servers 212 connect to particular web pages specified by uniform resource identifiers (URIs) in the agent job specification. The agent servers 212 then perform an authentication as specified in the job specification and retrieve information from the specified URI according to a script attached to the agent job specification. In one embodiment, the script includes a set of steps defined in an xml file that indicates what element on a web page should be activated and with what parameters. As discussed above, the parameters include the one or more triggers 114 defined in the information hierarchy 100.

In one embodiment, the agent job specification includes a scope field and a history field. The scope field specifies how deep to traverse the web site (e.g., traverse a single page, traverse a plurality of pages up to specified level, or traverse all of the pages within the web site). The history field specifies whether only the pages newer than a previous traversal, if any, of the web site should be collected or whether all of the pages should be collected. The agent servers 212 are configured to traverse the specified URI according to the scope field and the history field. The agent servers 212 compare collected web site pages against any previous traversal history based on the page modified date.

The agent servers 212 periodically provide updates on the progress of the traversal of a web site. For example, the agent servers 212 may provide an indication to the agent controller/scheduler 228 of a current web page that is being traversed and a list of web pages already traversed as part of a particular agent job. The agent servers 212 provide reliability information to the agent controller/scheduler 228 in terms of ability to connect to a requested source, and the progress of the collection. The agent servers 212 report any errors or timeouts that occur when traversing specified URIs as part of a particular agent job. Errors raise an alert that can be handled by the system 200 and/or a user. Problems with a particular source are also raised as an alert.

While traversing the web pages, the agent servers 212 receive http and/or https outputs and provide the outputs to the agent controller/scheduler 228 for the agent controller/scheduler 228 to parse and save.

In one embodiment, the agent job specification is an xml structure that describes the steps that the agent servers 212 are to take in the traversal of a specified URI. The agent job specification may be exchanged, for example, between the agent application and main application over simple object access protocol (SOAP) or another inter-machine communication method.

The following pseudocode provides one example of an agent job specification:

```
<AGENT>
  <ID>
    <JOB ID>123</JOB ID>
    <RUN ID>12361</RUN ID>
  </ID>
  <HISTORY>
    <DIFFERENTIAL> YES/NO </DIFFERENTIAL>
    <LAST RUN DATE>2004-09-19 08:00:00</LAST RUN DATE>
    <LAST TRAVERSAL>
      <URI>
      <DATETIME>2004-09-19 08:00:00</DATETIME>
      <URI>http://xxxx/xxxx/xxx.html</URI>
      </URI>
      <URI>
      <DATETIME>2004-09-19 08:00:00</DATETIME>
      <URI>http://xxxx/xxxx/xxx.html</URI>
      </URI>
    </LAST TRAVERSAL>
  </HISTORY>
  <SCOPE>
    <SCRIPTED YES/NO />
    <SCRIPT>
      <STEP>
      <URI>http://xxx/xxx/xxx</URI>
        <FORM>
        <ID>FormZ</ID>
        <INPUT ITEM>
          <ID>Query</ID>
          <VALUE>Where is Valdo?</VALUE>
        </INPUT ITEM>
          <ACTION ITEM>ButtonX</ACTION ITEM>
          <ACTION>Submit/js:click/link/result
          </ACTION>
        </FORM>
  </SCRIPT>
  (NOTE: There can be many steps and they can be embedded)
  <NOSCRIPT>
      <TOP URI>http://xxx/xxx/xxx</TOP URI>
      <DEPTH> PAGE ONLY/N-where N is the page
        level of traversal </DEPTH>
      <SPAN>Yes/No</SPAN>
    </NOSCRIPT>
  </SCOPE>
  <AUTHENTICATION> NONE/BASIC/WINDOWS
  </AUTHENTICATION>
  <LOGIN>
    <UID xxxx />
    <PWD @@@@ /> (This may be encrypted so that
      sniffing would not help attacker)
  </LOGIN>
  <HTTPS>
    <CREDENTIALS>xxxxx</CREDENTIALS>
  </HTTPS>
  <PROGRESS>
    <FREQUENCY>Every URI/Lump</FREQUENCY>
  </PROGRESS>
</AGENT>
```

An artisan will recognize that the pseudocode listed above is provided for illustrative purposes only and is not intended to limit the disclosure. The ID structure includes tracking numbers used by the agent controller/scheduler 228 to know where to save the results and report on the progress of the particular agent job. The JOB ID uniquely identifies the particular agent job and the RUN ID uniquely identifies a particular execution of the particular agent job. In one embodiment, the RUN ID is sufficient for storing information so as to eliminate a need for composite keys.

The HISTORY structure includes a differential field that specifies whether the agent is to report only items newer than a previous run of the particular agent job or whether the agent is to report all data collected for the particular agent job. If the differential field is set to YES, then only URIs that have modified dates that are more recent than the date specified in the LAST TRAVERSAL structure will be uploaded.

The SCOPE structure indicates a depth of traversal or a script that is to be used to extract information from database driven web sites. If the differential SCRIPTED field is set to YES, then the SCRIPT is read by the agent and the specified actions therein are applied until the last step, which may specify a “result” action. The agent reports any errors in the execution of the script such as when a file is not found, access is denied because authorization is required, access is forbidden, a timeout occurs, an invalid action is attempted, or other errors occur.

If the SCRIPTED field is set to NO, then simple traversal of the URI is to be performed. The NOSCRIPT section includes the definition of the TOP URI and the DEPTH of the traversal. The DEPTH can be PAGE ONLY, indicating that the page specified is the result and it will be the only page traversed for this particular agent job. Alternatively the DEPTH can be an n-level deep traversal. N-level deep traversal indicates that the page links are to be traversed up to N levels deep with the first level counted as 1 or the first page. Note that PAGE ONLY is equivalent to N where N=1.

The SPAN parameter defines whether the traversal should occur only within the top URI specified or if the links are to be traversed outside of the site for up to N levels or hops. The AUTHENTICATION parameter specifies the level of authentication required to gain access to the specified URI. Possible authentication methods include NONE, BASIC, and WINDOWS. FORMS based authentication is handled through scripts because the INPUT ITEM and SUBMIT ITEM identifiers generally need to be discovered and scripted. For BASIC, WINDOWS and FORMS authentication, the LOGIN section includes CREDENTIALS to identify a user's authorization to access the web site. In some embodiments, a password field PWD is encrypted so that sniffing the packets does not reveal site login information. In other embodiments where the job specification can be accessed outside of a trusted network, the job specification itself is encrypted.

Returning to FIG. 2, according to one embodiment, the agent servers 212 do not store persistent information thereon. As discussed above, the agent servers 212 are isolated from the rest of the system 200 so as to maintain security. By not storing persistent information on the agent servers 212, an attacker will be less likely to discover what information the agent servers 212 are seeking and/or what information the agent servers 212 have already collected. The agent servers 212 behave as pure pass through machines. In one embodiment, additional security is provided by encrypting communications between the agent servers 212 and the web application server 210 and/or the web services server 214. For example, in some embodiments, one or more of the servers may be located in a remote location such that it remotely communicates with the other servers over the Internet using encryption. However, in other embodiments, the servers 210, 212, 214 are part of the same secure network or computer and encryption is not used.

In one embodiment, the agent servers 212 are configured to parallel process many collection tasks. For example, multiple threads of execution or processes may be used. In addition, or in other embodiments, multiple tasks may be processed in parallel using multiple computers. The agent servers provide audit information such as collection start date/time, collection progress, and final collection results to the agent controller/scheduler 228. The agent servers 212 do not store audit information locally. Rather, the agent controller/scheduler 228 handles the collection and storage of the audit information using an application agent management protocol.

The agent servers 212 are configured to collect information from any web site in any language. The agent servers 212 preserve the collected data in its original form, including internationalization. Thus, the system 200 is useable by users throughout the world. In one embodiment, the system communicates with the other systems or networks such as the Internet using standard communication protocols such as http and https. For internal communications, the system 200 may use, for example, any available port over TCP/IP.

The web service tier 220 enables communication between the tiers 216, 218, 222. The web services tier 220 includes a web services server 214 that includes a persistence service module 230, an agent service module 232, a scheduler service module 234, a history service module 236, and a query service module 238. As discussed above, the persistence service module 230 is configured to receive a reported progress of an agent job, a payload of the agent job, a listing of images with image sizes and dates for the agent job, and processed payload text for the agent job from the agent controller/scheduler 228.

The persistence service module 230 is configured to save the information it receives in the database cluster 240. Since the agent servers 212 provide both original and processed information through the agent controller/scheduler 228, the persistence service module 230 is configured to store Unicode type text with binary objects as well as plain text in the database cluster 240. The information collected from the targeted URIs, including the associated images and the listing of images, is stored as the original response. The processed text is stored as one large text entry with subheadings for each of the URIs that were traversed as part of the agent job.

The agent service module 232 is configured to prepare the agent job specifications for the agent jobs in a format that is compatible with the agent controller/scheduler 228. The agent service module 232 retrieves requested agent jobs and related information from the database cluster 240 and packages the agent jobs into the agent job specifications along with previous agent traversal history, including dates and times. The agent service module 232 then transfers the agent job specifications to the agent controller/scheduler 228.

The agent service module 232 is also configured to monitor and report on the progress of the agent jobs. As discussed above, the agent service module 232 communicates with the agent servers 212 through the agent controller/scheduler 228. The agent service module 232 receives notification about the start, progress and completion of the agent jobs from the agent controller/scheduler 228.

The scheduler service module 234 is configured to activate agent jobs according to a user defined schedule. Thus, the user can specify when and/or how often information should be collected or updated.

The history service module 236 provides a listing of the traversed URIs for a specific agent job. Agent jobs may be recurring at predetermined intervals or when desired. Therefore, the history service module 236 provides a listing of job runs for each particular agent job was executed. Alternatively, the history service module may provide the history for only the most recently executed agent job. For any given job run, the history service module 236 provides a list of traversed URIs with dates and times of traversal.

In one embodiment, both the agent service module 232 and the web server tier 218 communicate with the history service module 236. Through the web application server 210, the history service module 236 can provide a user with a listing of the agent job runs and corresponding details such as the URIs traversed with accompanying dates and times.

The query service module 238 is configured to provide a list of URIs that represent a particular agent job. The query service module 238 provides a list of images for a specific URI that is part of the job traversal. In one embodiment, the list of images are ordered in descending size order. However, other orders, including by ascending size or random size, can also be used. The web application server 210 uses the query service module 238 to allow a user to specify specific URIs to include in a search for information related to a particular subject and/or the subject's social network.

As discussed above, in one embodiment, the system 200 transfers data using web service and/or TCP/IP packet exchange. However, in another embodiment, the system 200 exchanges internal data using files. For example, the agent service module 232 deposits an agent job specification as a first file in a predetermined directory. In one embodiment, the predetermined directory is stored on a hard drive (not shown) or network storage device (not shown) accessible by each of the agent servers 212. In another embodiment, the predetermined directory is also accessible by the agent controller/scheduler 228.

The agent controller/scheduler 228 periodically checks the predetermined directory for new files, including the first file, which it then accesses and processes. Once processed, the agent controller/scheduler 228 moves the agent job specification to an archive subdirectory. The agent controller/scheduler 228 generates a second file with a predetermined extension output that includes the outputs of the agent job. In one embodiment, the second file includes a compressed version of the output directory that is generated for the particular agent job. The agent service module 232 accesses the output file and loads it into the database cluster 240.

As shown in FIG. 2, in one embodiment, the database cluster 240 includes a plurality of databases 242 (three shown) configured to store collected information and other parameters, as discussed above. The databases 242 are in communication with a switch 244 configured to distribute data among the databases 242 according to known distributed networking techniques. Thus, the data in the databases may be protected so as to provide error correction and data recovery. An artisan will recognize that one or more of the databases 242 may be stand alone memory devices or may be part of one or more of the servers 210, 212, 214. An artisan will also recognize from the disclosure herein that only one database 242 may be used or that more than three databases 242 may be used.

In one embodiment, the web services server 214 includes a web application programming interface (web API) for performing services such as scanning a file for matches against data in the database cluster 240, performing distributed queries against multiple databases 242, performing distributed searches within http and/or https networks, and providing known security methodologies for web services. The web API includes a publishable web services description language (WSDL) that defines the web services that can be integrated into, for example, .net or j2ee platforms and allows quick integration with the database cluster 240. The web API is configurable through a web.config file for pointing to different databases and agents.

By way of example, in one embodiment, the web API includes function calls to create web service API objects and to search for subjects, information items and/or assessments. An information item is processed information that the user has analyzed and interpreted. An information item may include a title (provided by the user) and information content. An information item may also include original, raw information as an attachment. An assessment is a composite report on a topic that includes various information items and user provided content and/or abstract related to the topic. For example, a function call for searching for subjects may be in the form of: Subject SearchSubjects(string strSearchTerm). A function call for searching for information items may be in the form of: DataSet SearchInfoItems(string strSearchTerm). A function call for searching for assessments may be in the form of: DataSet SearchAssessments(string strSearchTerm).

The subject structure may include general information about the subject (e.g., Subject Key, Name, Description) and a subject type. To get subject type specific information, a function call may be used in the form of: DataSet GetSubjectsTypeInfo(int nSubjectKey). To get subject associations, a function call may be used in the form of: DataSet GetSubjectAssociations(int nSubjectKey). In this example, the dataset includes the associated subject key, a direction of association and an association description. Another exemplary function call is used to get subject association paths between subjects of interest. This may be done through the following call: DataSet GetSubjectPaths(int nSubjectKey). The returned DataSet includes paths as strings and/or xml structures and are appropriate for the paths that include keys, descriptions, associations and interest levels. Query call also include a Search Agent ID that is configured in the web.config of the web service.

As discussed above, cross-organization collaboration enables separate and/or geographically remote users 224 to share information in real time by applying custom access levels to each piece of information within the system 200. Information sharing levels include shared, hit only (or hit acknowledgment) and silent hit. In one embodiment, each piece of searchable information (e.g., Subjects, Information Items, Assessments) entered by the user would be assigned an information sharing level. Subjects, Information Items and Assessments can include combinations of information sharing levels. In one embodiment, the default for information sharing is “shared.”

When a query is issued to the web API that has the web service configured for a distributed search, the query is forwarded to registered agents and the retrieved information includes an agent source in addition to the regular search information in other datasets. For distributed search configurations, the web.config file includes the following example pseudocode:

```
<Agents>
  <Agent>
    <ID=”Local” />
    <URL=”http://localhost/discovery/query.asmx “ />
    <UID=””>
    <PWD=””>
    <DBConn=”This is connection string to local Nexight database” />
  </Agent>
  <Agent>
    <ID=”Customs” />
    <URL=”http://customs1/discovery/query.asmx “ />
    <UID=””>
    <PWD=””>
  </Agent>
  <Agent>
    <ID=”Police” />
    <URL=”http://police1/discovery/query.asmx” />
    <UID=””>
    <PWD=””>
  </Agent>
  <Agent>
    <ID=”Nexight Discovery”>
    <URL=https://discovery.nexight.com/discovery/query.asmx>
    <KEY=”Key provided from Nexight to User”>
  </Agent>
</Agents>
<InfoShare>
  <Outgoing Contact>
    <Name=BLDKDK />
    <Phone=999999999 />
    <Email=so@so.com />
  </Outgoing Contact>
    <Incoming Contact>
    <NexightID=Admin />
    <Name=DDFAA />
    <Phone=573467583 />
    <Email=so1@so1.com />
  </ Incoming Contact>
</Info Share>
```

An artisan will recognize that the pseudocode listed above is provided for illustrative purposes only and is not intended to limit the disclosure. Upon initialization of the system 200, the web services server 214 reads the agents from the web.config file and instantiates appropriate proxy classes for each call so that the returned datasets from the web API calls include all the result-sets from each agent. Note that each agent only returns public or shared information directly.

The DataSet for hit acknowledgement only includes agent, reference number and contact information for the source at the agent. The silent hit only sends an alert to the administrator for the silent hits at the agent site indicating that the request has been placed from the web API. The silent hit alert includes the identification of the agent that requested the information and the contact information. The outgoing contact information is sent to the web API caller for the hit acknowledgment situation. The incoming contact information is for the contact that would be contacted on the receiving end of the web API call for the silent hit notification. In the above pseudocode, the NexightID specifies a user that will receive the alert indicating that there was a hit for “silent” information.

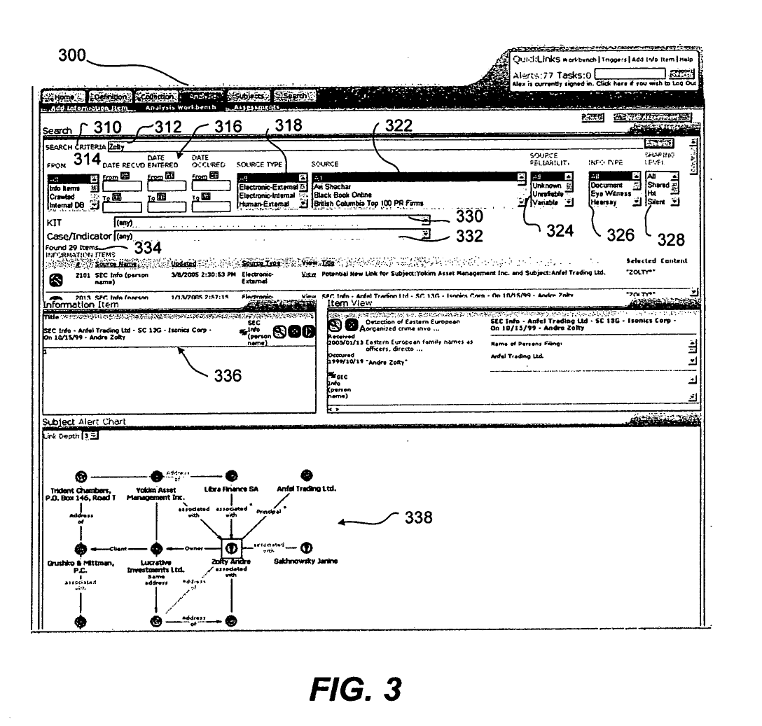

In one embodiment, the web API provides dynamic discovery of running agents in a network. In one embodiment, the web API provides a user interface for searching, analyzing collected data, and visualizing relationships between entities. For example, FIG. 3 is a general representation of a user interface 300 for analyzing relationships between entities according to one embodiment. The user interface 300 includes a search section 310 for specifying search criteria 312, one or more information locations 314, information date ranges 316, one or more source types 318, one or more specific sources 322, a source reliability level 324, an information type 326, and a sharing level 328, as discussed above. The user can also select an intelligence task 330 and a corresponding indicator 332 to provide context for the search.

The user interface 300 displays search results 334 and information items. As discussed in more detail below, the user interface 300 also includes a subject alert chart for visualizing relationships between entities.

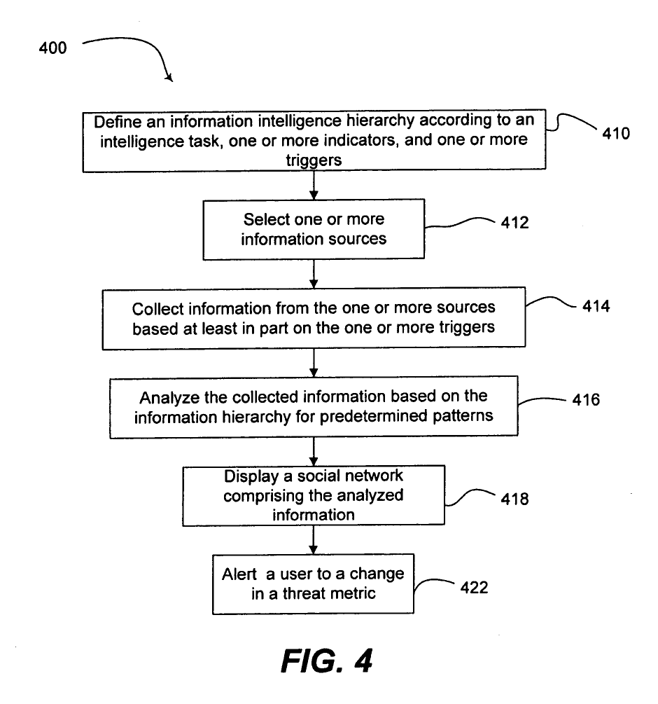

FIG. 4 is a flow chart of a method 400 for discovering and predicting behavior in a social network according to one embodiment. The method 400 is usable by the system 200 illustrated in FIG. 2. The method 400 includes defining 410 an information hierarchy according to an intelligence task, one or more indicators, and one or more triggers. As discussed above in relation to FIG. 1, the information hierarchy 100 allows the prediction of behavior in a social network based on analyzing information against the context of a threat or an event of interest. Defining the information hierarchy 100 provides the context for relationships between individuals and/or organizations.

The information hierarchy 100 allows collection and monitoring of information within a desired context for a network of subjects. Valuable information is therefore related not only to the information hierarchy 100, but also to the involved subjects and their social networks. Metrics are created that measure the contextual activity in the subjects' networks from which the probable threat level of an event can be established. For example, an activity metric measures the number of discovered hits corresponding to the information hierarchy 100.

By having the context of the information hierarchy 100 and the social network, the events of interest can be modeled in a consistent, systematic manner. The patterns detected in seemingly small events within a network when viewed against the backdrop of the information hierarchy 100 context become easier to analyze. Moreover, the historical events and sequences of events can be used as training cases of artificial intelligence (AI) constructs such as neural networks, decision trees, Markov chains or Bayesian networks. Thus, AI can provide an automated strategic intelligence platform that can predict future behavior of a social network based on impartial known event occurrences.

The method 400 also includes selecting 412 one or more information sources for gathering and monitoring of information. Information sources include, for example, internal databases, internal network drives, flat files corresponding to internal web pages, internal database driven web pages, external databases, flat files corresponding to external web pages, and external database driven web pages. The user can select information sources depending on the specific information to be collected or monitored.

The method 400 also includes collecting 414 information based at least in part on the one or more triggers 114. As discussed above, in one embodiment, automated agents search for and collect information from the selected sources. A web server generally stores web site pages as flat files in a directory on the web server. These flat files can be searched using search parameters defined by the one or more triggers 114. However, the flat files may represent only a small portion of the information available through the web server. For example, it is estimated that flat files corresponding to web sites on the Internet represent approximately 1/100^{th} of the information available on the Internet.

A large portion of the information available on the Internet is stored within web sites that are database driven. To access database information through a web page, a user generally passes parameters (e.g., search parameters or requests for information) to the web page. In response, the web page returns database information corresponding to the user's parameters. In one embodiment, an intelligent agent passes query parameters to a database driven web site and extracts the returned information for further analysis. The intelligent agent may be driven through, for example, an extensible markup language (xml) based agent language that describes a multi-step, conditional, generic impersonation of a user. The triggers 114 specify query parameters and the intelligent agent processes the query parameters to extract database information based on the query parameters.

The method 400 also includes analyzing 416 the collected information based on the information hierarchy 100 for predetermined patterns. The information collected from the specified sources is stored in an internal database and indexed. The collected information is searched to detect the specified triggers 114, identify a new subject of interest, and identify relationships between two or more subjects. If a trigger 114 is detected, an alert corresponding to the information hierarchy 100 is generated.

In one embodiment, the alert is provided to subscribed users in an alert inbox. Each user can process the alert as desired. A user may, for example, add the alert to an “information item” that includes the original information that triggered the alert, a title, and comments, if any, added by the user. Alternatively, the user may dismiss the alert. In one embodiment, the processing activity of each user is tracked individually.

A user may create a subject identification task to automatically identify new subjects. The subject identification task searches the specified sources and/or the collected information for one or more combinations of trigger patterns. If the trigger patterns are detected, a discovered subject alert is displayed in a discovered subjects inbox for the user. The patterns may include, for example, “company with legal counsel in New Jersey, with business in Vancouver, and registered in Nevada.” If the specified sources and/or collected information includes the triggers “New Jersey,” “Vancouver,” and “Nevada,” a new subject alert is generated. The information that was used to identify the new subject is associated with the new subject as an information item. In one embodiment, the new subject alerts are only provided to the user who created the subject identification task for initial processing.

Subject link identification tasks identify relationships between two or more identified subjects. The subject link identification task generates combinations of identified subjects and searches the collected information for the triggers 114 corresponding to the combined subjects. For example, the subject link identification task may identify information that indicates that “entity A is a lawyer of entity B,” where entity A and entity B are both subjects of interest. If the combined triggers 114 are detected, a new potential subject link alert is generated and provided to the users. In one embodiment, the subject link alert includes the type of association discovered between the subjects and a link to the information that includes the association.

The method 400 also includes displaying 418 a social network comprising the analyzed information. Displaying the social network allows the user to gain additional insights into the collected and analyzed data. Searching for social networks allows for the discovery of relationships between seemingly innocent entities and the subject of interest. As the social networks are built, the social network of the entities becomes complex and very difficult or impossible for human search and/or analysis. The systems and methods discussed herein enable quick and efficient searching for social networks that often exhibit a “small world” phenomena where a large number of entities are related through a certain degree of separation. That is to say, social networks are made up of clusters of highly intertwined entities that share some common characteristic (e.g. profession, location, culture) with long jumps (e.g., in terms of various dimensions and/or geographic) that connect the clusters.

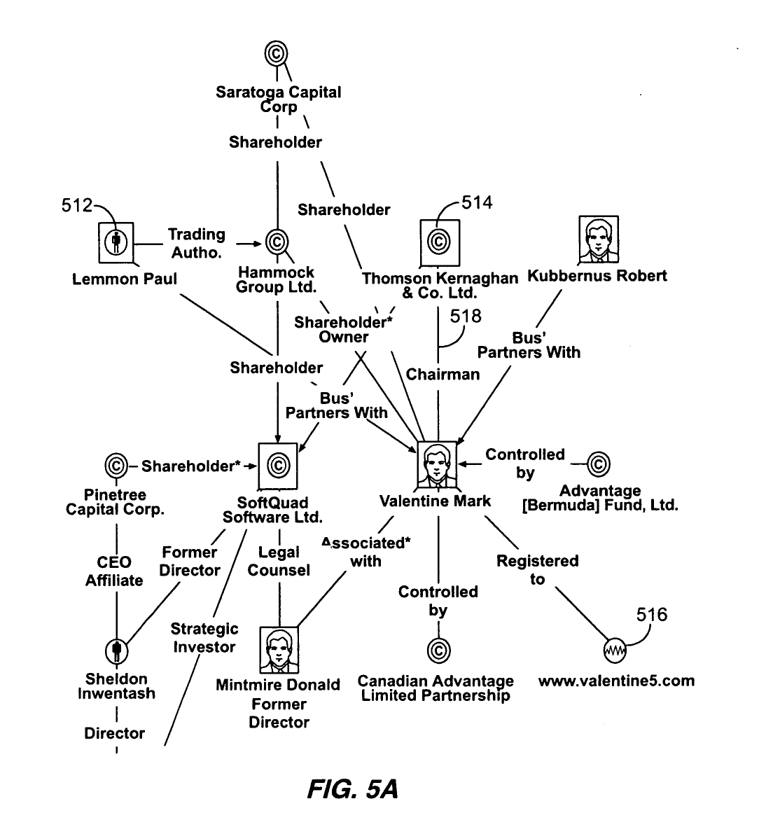

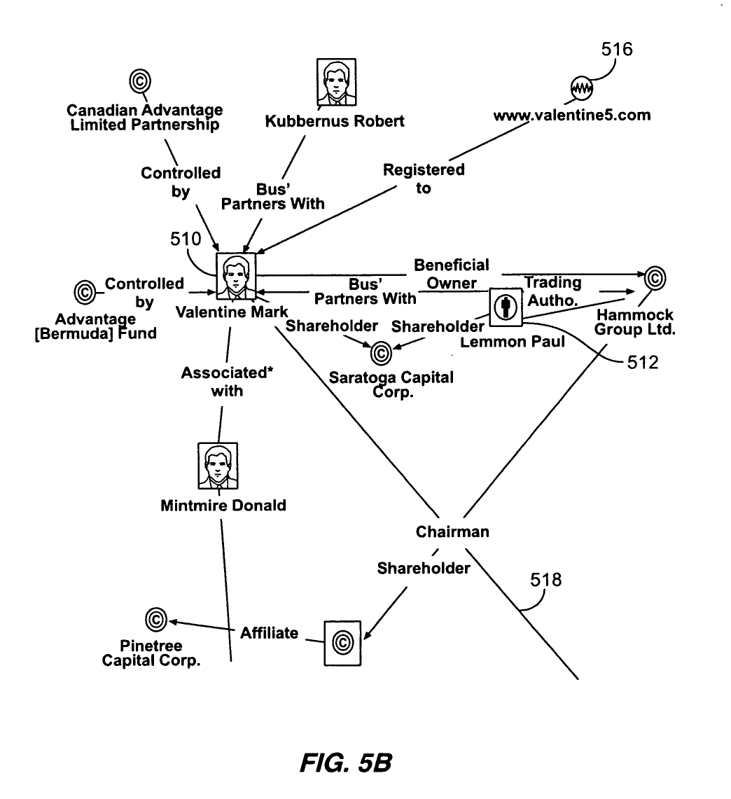

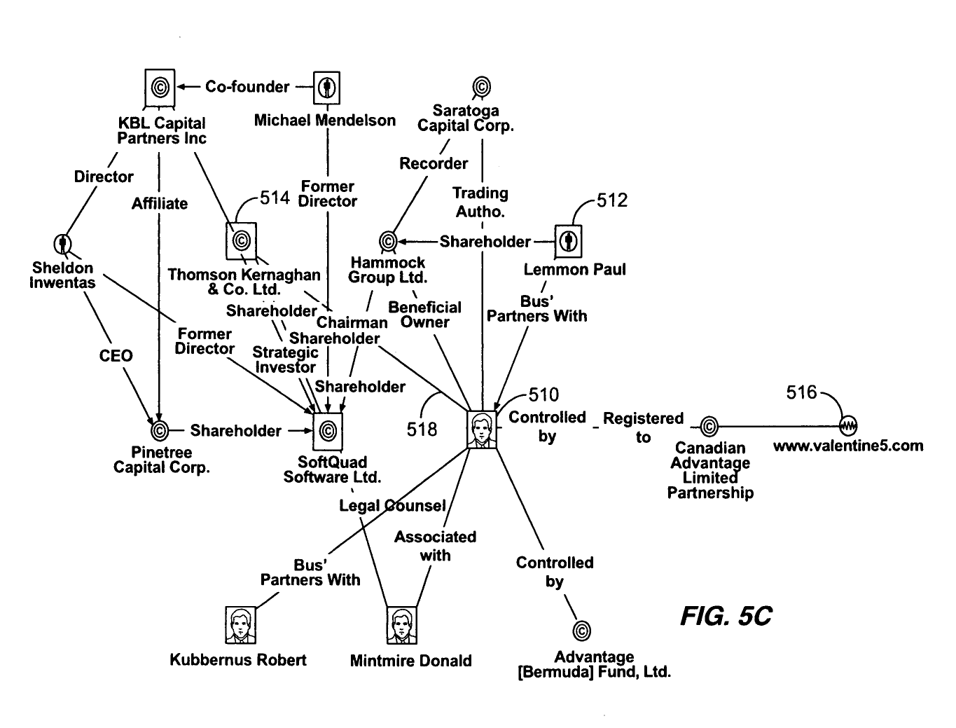

In one embodiment, link charts are automatically generated based on the analyzed data. The link charts allow the user to visualize relationships between entities and further analyze the collected data. For example, FIGS. 5A-5C are partial link charts illustrating relationships between entities in a social network. In the example shown in FIGS. 5A-5C, a subject named Mark Valentine 510 is displayed along with links to other entities. The other entities may include, for example, individuals (e.g., Paul Lemon 512), businesses (e.g., Thomas Kernaghan & Co. LTD.), web sites (e.g., www.valentine5.com 516), or other types of entities.

The links between entities display the type of relationships between the entities. In one embodiment, the user may select a link to view additional information related to the link and/or the source of the link information. For example, the link 518 between the subject Mark Valentine 510 and Thomas Kernaghan & Co. Ltd. 514 indicates that Mark Valentine 510 is the chairman of Thomas Kernaghan & Co. Ltd. 514. The user may select the link 518 to view, for example, a document or web page that indicates or discusses the “chairman” relationship.

Other types of relationships between entities may include, for example, kind of, has, part of, connected with, married, works for, works with, lives near, mistress, related to, business partner with, works near, drives, has phone number, employs, manages, registered to, seen with, uses, master, husband, family relation, brother, subsidiary, lives in, president, managing director, director, chairman, business address, beneficial owner, trading authority, shareholder, associated with, same address, promoter, former CEO, friends, principal, address of, consultant, legal counsel, owner, may be related to, managing member, former director, manager, CFO, secretary, client, controls, signing member, CEO, vice-president, father, and controlled by. Artisans will recognize from the disclosure herein that other types of business and personal relationships may also be displayed.

The chart in FIG. 5A is illustrated in a grid layout. The grid layout is achieved by laying out entities in a grid. The chart in FIG. 5B is illustrated in a grid-clustered layout wherein entities with the most or a high number of connections are placed far apart from each other in a grid so as to avoid or reduce the amount of overlay. The chart in FIG. 5C is illustrated in a grid-offset layout. Grid-offset layout is achieved by adding an additional grid to an original grid with an offset of half the grid unit distance. The two offset grids provide more grids that are not horizontal or vertical. Rather, the connections are on various angles so as to reduce overlays. An artisan will recognize from the disclosure herein that other layouts may also be used. For example, a circular layout used in conventional html visualization software may also be used.

In one embodiment, social networks are determined by building n-depth trees for both subjects of interest and for a searched subject. Intersections between the n-depth trees indicates a relationship between the entities. Building the n-depth trees forms social clusters. The intersections of clusters can be quickly identified to see if there are any cross cluster jumps that indicate relationship paths.

The n-level network algorithm creates sets of n-level depth networks and stores them. The sets have the list of all the entities that are involved in an n-level depth network. The sets are specifically created and preserved for the entities of interest. To see if an entity is connected to any entities of interest, the algorithm creates the entities n-level depth network set and checks for any intersections between this set and the network sets for the entities of interest. Standard relational database technology is very efficient at handling the intersection of sets. Generally, a set corresponds to a table and an intersection corresponds to an inner join. Thus, the problem of finding the paths to the entities of interest is reduced to running inner joins on the network sets of the entities of interest and a currently selected entity.

The intersections between the clusters are found by reducing the n-depth trees to sets of subjects so that the intersection of the trees becomes a question of intersecting sets. Thus, set theory (e.g., a relational database table inner join) can be used. In one embodiment, the n-depth trees and associated sets are pre-built and updated in real-time as changes to the social network occur to thereby provide an effective caching mechanism. Identifying intersections between n-depth trees is generally efficient when the number of entities of interest is smaller than the number of paths defined by (2n-depth tree paths)−(n-depth tree paths). However, this is usually the case. For example, as the number of entities increases, the number of paths in the social network generally increases exponentially.

By way of example, one way to visualize finding the intersection between n-depth trees is by imagining that the branches of the n-depth trees that include the entities of interest are infected. To know if the current entity is connected to entities of interest, a current entity branch may be checked to see if it touches the infected branches. An artisan will recognize that some networks are more like meshes than the branches of trees and that the discussion of tree branches is for illustration only. However, it can be seen that looking for connections to infected branches is more efficient than traversing 2n-level depth trees.

For example, assuming that there are 1000 entities of interest and that the entities are in well connected social networks, the number of paths that need to be evaluated to verify connection between the current entity and entities of interest are (1000+1)*1000 paths, which is approximately 10⁶ paths to evaluate to look for “infected” connections. Here, (1000+1) is the number of entities of interest plus the current entity and the 1000 multiplier is the number of 3-level deep network paths (using a growth multiplier of 10). However, for 2n-level traversal, the number of paths that need to be evaluated is 1000*10⁶ paths, which is 10⁹ paths. Here, 1000 is the number of entities of interest and 10⁶ is the number of 6-level deep network paths.

Returning to FIG. 4, the method 400 also includes alerting 422 the user to a change in a threat metric. Subject pattern identification tasks identify specified patterns in the collected information. The patterns include combinations of triggers 114 that imply that the specified subject is an increased risk or threat. In one embodiment, an increased threat metric is automatically displayed in the social network link charts discussed above in relation to FIGS. 5A-5C.

III. Example Embodiment

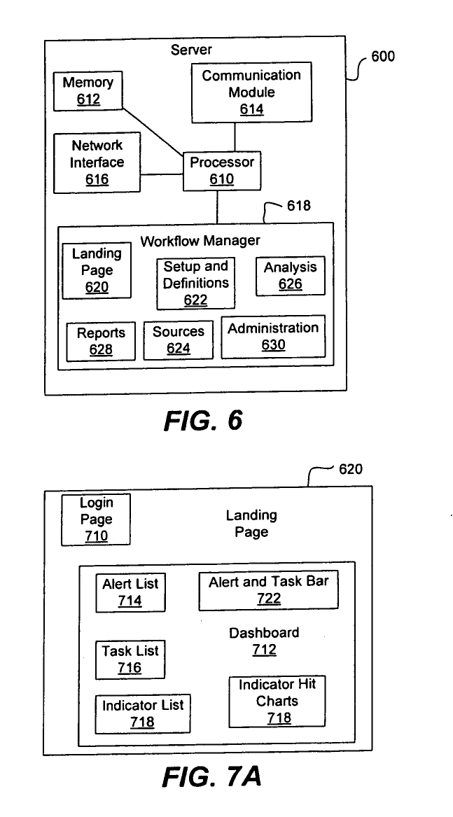

FIG. 6 is a block diagram of an exemplary server 600 for collecting and analyzing information related to a subject and the subject's social network according to one embodiment. An artisan will recognize from the disclosure herein that the discussion of FIG. 6 and other corresponding figures, including user interfaces, is for illustrative purposes only, and that many alternative elements, user interfaces and/or methods may be used. For example, as discussed above, the server 600 may comprise a plurality of separate servers that may be distributed across a network or plurality of networks.

The server 600 includes a processor 610 in communication with a memory 612, a communication module 614, a network interface 616, and a workflow manager 618. The processor 610 may include, for example, a single-processor or a multiprocessor device. The memory 612 includes at least one software application that can be executed by the processor 610 to collect and analyze information as described herein. The communication module 614 communicates with a user and may include, for example, a keyboard, a mouse, a display device, a printer, a speaker, a microphone, a combination of the foregoing, and other user communication devices. The server 600 is configured to communicate over a network (not shown) using the network interface 616. The network may include, for example, the Internet or World Wide Web, or an intranet such as a LAN or WAN, or any other network of communicating computerized devices.

The workflow manager 618 provides an application that enables collection of information from many different sources. The workflow manager 618 integrates the collected information and analyzes the collected information for preset targets. The workflow manager 618 also provides reporting on the results of the analysis. The workflow manager 618 streamlines analytical processes and ensures reliable collection and processing of large amounts of information.

The workflow manager 618 may be used, for example, by organizations to search for sensitive information where even the knowledge of someone searching for such information presents a significant breach of security. The workflow manager 618 is used to “cover ones tracks” by keeping all collection sources and collected information secure, appropriately classified, and protected. The workflow manager 618 uses a controlled workflow that provides reliable collection, storage, and automated analysis of collected information. In one embodiment, users may connect existing databases of information to the workflow manager 618 through an internal database connector functionality so that the databases become searchable sources of information. As discussed below, information in the user's existing databases may be mapped to the information hierarchy used by the workflow manager 618 with appropriate classifications.

In one embodiment, the users are separated into administrators and other users. The administrators perform system administration functions such as setting up the system, establishing connectivity to databases, creating scripts for collection of information from form based sites, and other system related configuration tasks. The user's ability to see and deal with (e.g., add, edit, delete) information is controlled through an access level property.

The other users are considered to be information analysts having different access levels. In one embodiment, the access levels are high, medium, and low. The users' access level determines which information and information sources they can access. For example, Table 2 illustrates an access level matrix according to one embodiment that describes the available access for users of classified sources and information.

TABLE 2

| USER | INFORMATION | | SOURCE | |
|---|---|---|---|---|
| ACCESS | CLASSI- | NON- | CLASSI- | NON- |
| LEVEL | FIED | CLASSIFIED | FIED | CLASSIFIED |
| HIGH | Yes | Yes | Yes | Yes |
| MEDIUM | Yes | Yes | No | Yes |
| LOW | No | Yes | No | Yes |

In one embodiment, the workflow manager 618 is implemented as an asp.net web application. Thus, browser access is provided from anywhere within an organization (e.g., of authenticated users) without a need for installation on client computers. In one embodiment, however, a visualization tool may be installed on client computers corresponding to a subset of users. For example, in non-windows organizations, one or two windows servers (or Linux/Mono servers) provide the methods discussed herein. Thus, a plurality of windows-based application does not need to be installed on every user's computer. Having the application as a web application also allows distribution of the application as a service and providing remote collection capabilities. Thus, cooperation is promoted with an organization and across a plurality of organizations.

The workflow manager 618 provides a user with an ability to establish one or more sources of information and define intelligence tasks, indicators and triggers. Thus, the user can establish goals and indicators that drive the information collection process. The intelligence tasks, indicators and triggers are discussed above in relation to FIG. 1. The workflow manager 618 also performs the collection of the information through automated and manual collection steps. The collected information is automatically compared to the triggers and alerts are generated when triggers are discovered. The workflow manager 618 performs an analyses by processing the alerts, adding information against an appropriate case, and interpreting the information. The workflow manager 618 generates an assessment that includes findings, background information, and sourcing.

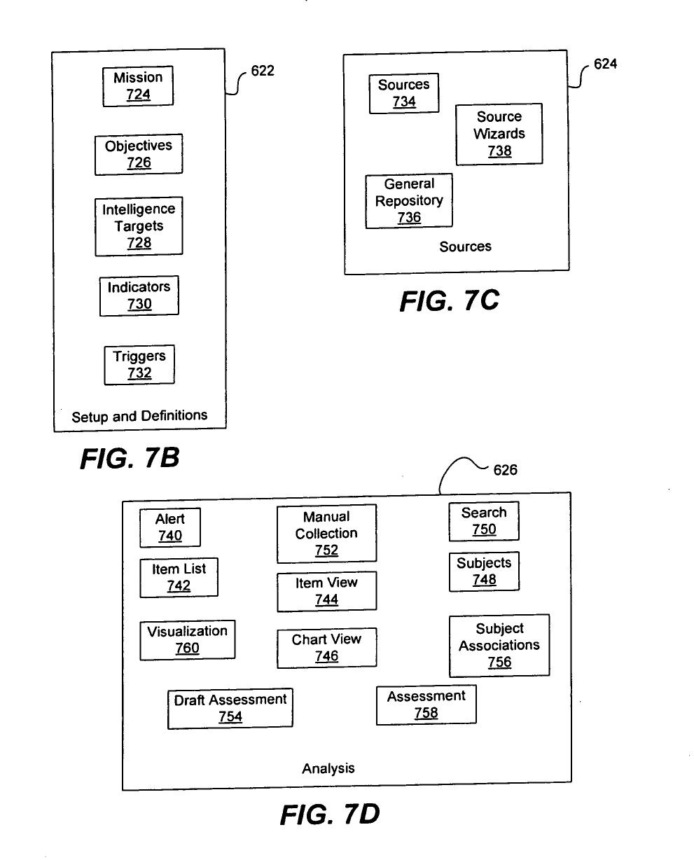

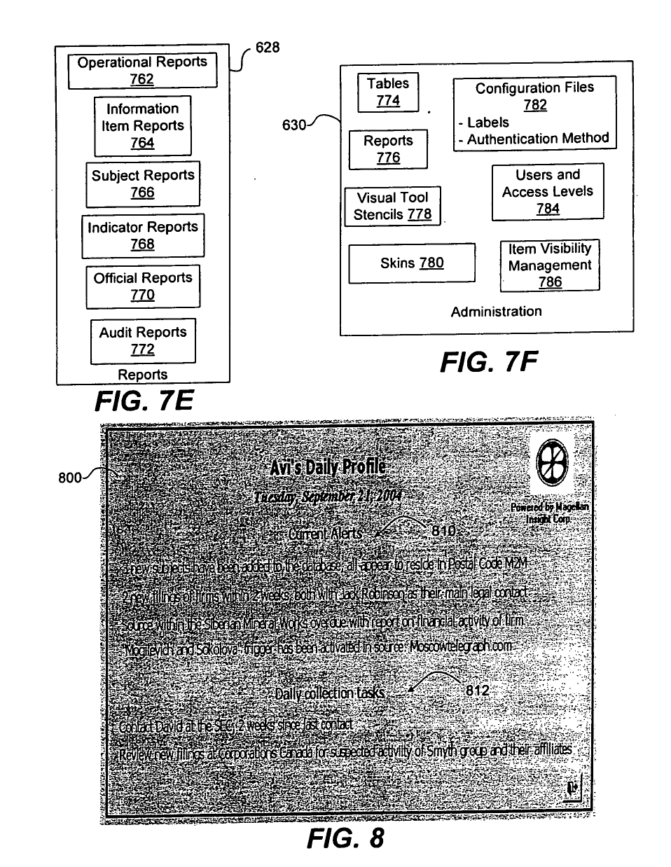

The workflow manager 618 includes a landing page module 620 (see FIG. 7A), a setup and definitions module 622 (see FIG. 7B), a sources module 624 (see FIG. 7C), an analysis module 626 (see FIG. 7D), a report module 628 (see FIG. 7E), and an administration module 630 (see FIG. 7F). Each of the modules 620, 622, 624, 626, 628, 630 are described in detail below.

A. Landing Page

FIG. 7A is a block diagram of the landing page module 620 according to one embodiment. The landing page module 620 provides a quick insight into a current state of the information collection and analytical processes of the workflow manager 618. As discussed below, visualization techniques may be used to provide the insight. The landing page may be automatically refreshed at predetermined time intervals that may be set, for example, in a configuration file by a user such as a system administrator. In one embodiment, a default span for hits displayed in visualization graphs is a rolling week (e.g., one week from a current time going back). However, the user can also modify the default span in the configuration file.

The landing page 620 includes a login page 710 and a dashboard 712. The login page 710 establishes the user's access level. In one embodiment, a form-based security procedure is used to prompt the use to enter a login name and password. In another embodiment, the login page 710 uses windows security such that the user will not have to login into the application. Rather, the trusted windows login credential is used for user authentication. In such an embodiment, only users that have been defined as users of the application by, for example, a system administrator will be able to access the application. When using windows authentication, the login page 710 uses a {Domain}\User Name type of structure and additional passwords will not be required.

The dashboard 712 provides a common header and/or a common footer for web page display and navigation. The common header may include, for example, an organization's logo and menu options that a user can access to navigate between web pages. The common footer may include, for example, links to information about the application, information about a provider of the application, and copyright information. The footer might may be customized for different users. Thus, in one embodiment, the common footer is defined in a separate file so that changes to the footer can be accomplished in one place.

The dashboard includes an alert list submodule 714, a task list submodule 716, an indicator list submodule 718, an indicator hit charts submodule 720, and an alert and task bar 722. The alert list submodule 714 includes a list of top N alerts of following format: date received, source type, assigned user (e.g., an assigned analyst), triggers activated in the collection task, one liner (e.g., the amount of text from the alert that can fit on the screen in one line), and alert status. The user can modify the number N, which may have a default value of 10 or 20 in certain embodiments. The information in the alert list is sorted by date received in ascending order. However, other sorting methods can also be used. The user can change the sort type to any of the alert fields.

The name of the assigned user or analyst for the alert is included in a staff field in the collection task definition. Administrators, for example, have the option of reassigning the alerts by clicking on an icon beside the staff field. An administrator or other users can reassign the alerts in bulk for a selected time period.

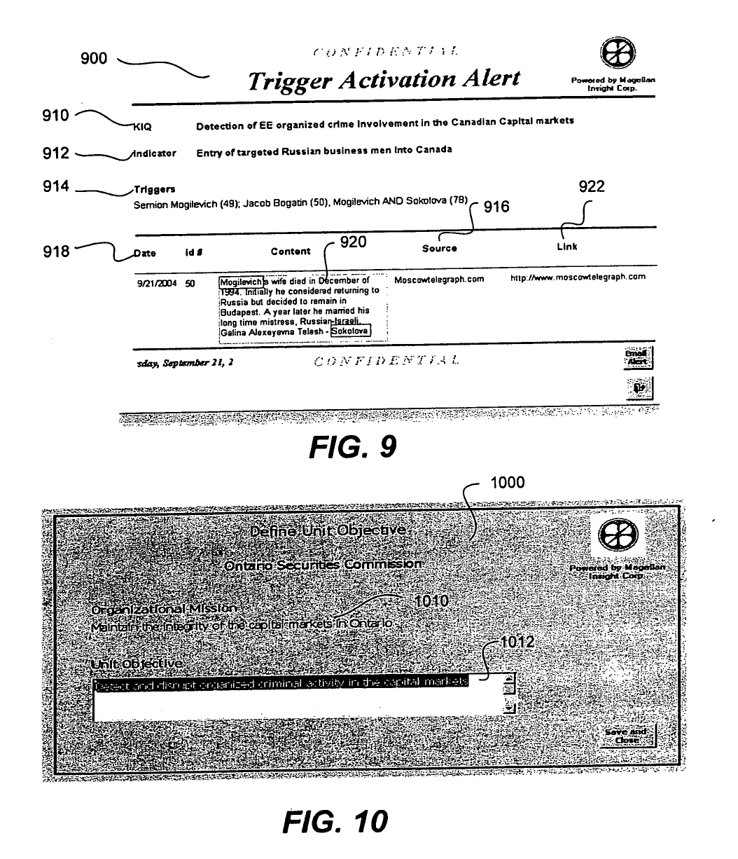

The alert list submodule 714 includes a status field that indicates the status of the alert. The alert status can be, for example, sent to user X, dismissed, in queue, or processed by user Z. The user can select whether or not to display alerts that do not include any further information. In one embodiment, each alert includes a hyperlink that opens an alert page (see FIG. 9) corresponding to a selected alert.

The task list submodule 716 includes a list of tasks comprising actions that the user specifies during the analysis process that need to have manual attention. A task may include, for example, the collection of an information task or a reminder task. Tasks perform the role of a “manual scheduler” (as compared to an automatic “agent scheduler”). For example, substantially the same information that an agent receives and processes automatically (e.g., time and date, source, triggers, frequency, and other parameters discussed herein) is provided to a user for manual attention. The user may select a listed task to view a manual task collection page.

The user may generate an alert from the manual task collection page and/or send the alert information to a general repository. The user may also generate reminder tasks that specify a need or desire to follow up on a particular alert. In one embodiment, the user can reassign a task to another user. For example, the user may not be able to complete the task because of absence or the other user may be more capable to complete the task. For example, some users are more efficient at information collection processes while other users are more efficient at assessment processes.

FIG. 8 is a general representation of a user interface 800 that displays a user's “daily profile” of current alerts 810 and daily collection tasks 812. The user may select the items listed in the current alerts 810 and daily collection tasks 812 to view additional information related to the selected item.

The indicator list submodule 718 includes a list of indicators comprising medium level objectives that a user is trying to achieve and against which the user specifies triggers or searches. The indicator list submodule 718 provides a dashboard representation of the indicators. In one embodiment, the colors of an indicator are related to an importance associated with the indicator. For example, green my indicate that the indicator is very important, yellow may indicate that the indicator is important, and white may indicate that the indicator is less important.

In one embodiment, the indicator has the following fields: information task, importance, indicator one liner, and number of hits. The user can click on the indicator list to see an indicator link chart. The indicator link chart is a link chart that shows all the associated subjects (e.g., people, organizations, locations, vehicles, phone numbers, and the like) related to the selected indicator. When the user clicks on the indicator, the user can see the list of all the alerts (hits) associated with the selected indicator. The indicator list submodule 718 handles each of the alerts in the same way as the alert list submodule 714.

The indicator hit charts submodule 720 generates graphs that are visible and/or accessible from the landing page 620. For example, the indicator hit charts submodule 720 may generate a chart that shows hits by source over time and/or cumulatively. The chart may include, for example, a breakdown of time, days, or hours to show that a given source produces hits only at certain times.

As another example, the indicator hit charts submodule 720 may generate a chart that shows hits per trigger per source. The chart may be normalized relative to the number of attempts to collect the information from the source. For example, the charts may identify that a given trigger produces no hits for all sources, or for certain sources. The user may then revaluate the use of the trigger. Grades on the chart may indicate a weighted hit grade. The weighted hit grade may include, for example, a weight factor multiplied by a 1 for a hit or a 0 for no hit. For example, an indicator with a 20% weight having one hit gives a 0.2 grade. Five hits with a 20% weight gives a 0.1 grade. An indicator with an 80% weight having two hits gives a 1.6 grade. Five hits with an 80% grade gives a 0.4 grade.

The alert and task bar 722 shows the number of alerts and tasks and is refreshed at a predetermined rate. The predetermined rated may be selected by changing a parameter in the configuration file. Thus, the user notified of new alerts and can respond to changes in the alert and taskbar 722. In one embodiment, the alert and taskbar 722 is always visible in the top right corner of the user's screen.

FIG. 9 is a general representation of a user interface for an alert page 900 that displays available alert information. The alert page 900 displays information such as a key information question (KIQ) 910 (also referred to herein as an information task), an indicator 912, one or more triggers 914, an information source 916, relevant dates 918 (e.g., received date, event date), a textual representation of the data 920, a link to the original data 922, the original data in a viewer for HTML data (not shown), a list of images associated with the alert sorted in descending size order (not shown), any action that any of the users have taken on the alert (not shown) (e.g., dismissed by a particular user), and an assigned user (not shown). In some embodiments, exact matches of words that show up in the trigger 914 are highlighted in the searched text 920.

Given the information provided in the alert page 900, the user may select an appropriate response including dismissing the alert, accepting the alert upon which the user will be directed to an analysis page where the user can add portions of the alert an information item, accepting the alert and add as an information item to another indicator, and creating a manual alert that generates an alert when performing a manual collection. The user can fill in the above information fields as the result of a search and/or information collection process. In one embodiment, the user receives a weekly inactivity report that displays the last hit for a particular trigger. The user's actions in terms of acting on an alert are recorded for the purposes of generating alert audit reports.

B. Setup and Definitions

FIG. 7B is a block diagram of the setup and definitions module 622 according to one embodiment. The setup and definitions module 622 is used to define an information hierarchy, such as the information hierarchy 100 shown in FIG. 1. The setup and definitions module 622 includes a mission submodule 724, an objectives submodule 726, an intelligence targets submodule 728, an indicators submodule 730, and a triggers submodule 732.

The mission submodule 724 generates a web page where the user can see and edit a mission statement. The mission statement is a simple text statement that defines an overall goal of the user or the user's organization. For example, FIG. 10 is a general representation of a user interface 1000 for entering and editing mission statements 1010 and objectives 1012. As shown in FIG. 10, a mission statement 1010 for the Ontario Securities Commission may be, for example, to maintain the integrity of the capital markets in Ontario. In one embodiment, there is no length limit to the field corresponding to the mission statement 1010.

The objectives submodule 726 generates a web page where the user can see and edit a set of one or more objectives corresponding to the defined mission statement. Objectives are simple text statements that define the strategic intelligence goals of the user or the user's organization. In FIG. 10, for example, one objective 1012 of the Ontario Securities Commission is to detect and disrupt organized criminal activity in the capital markets.

The intelligence targets submodule 728 generates a web page where a user can see and edit intelligence targets, such as the intelligence task 110 shown in FIG. 1. The intelligence targets may be referred to herein as intelligence tasks, key intelligence questions, or key interest questions. Intelligence tasks are statements that define the operational goals of the user or the user's organization. The intelligence tasks may be related to specific activities of a known subject or an organization. Subsequent collection of information and analysis is performed within the context of the information tasks.

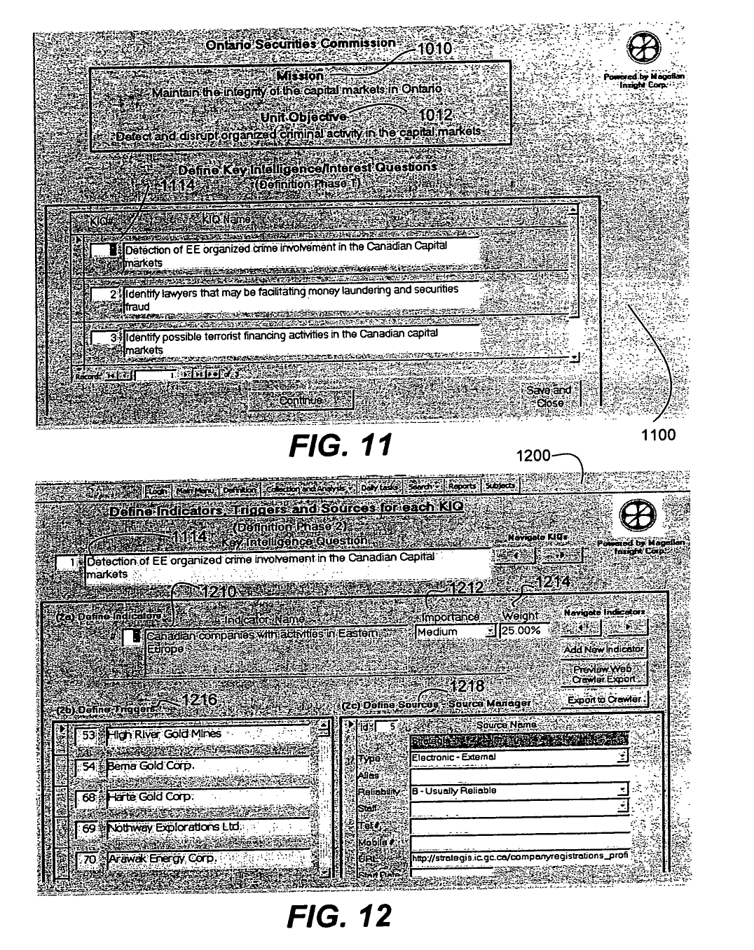

An a user or organization can have a number of intelligence tasks. For example, FIG. 11 is a general representation of a user interface 1100 for entering and editing multiple intelligence tasks 1114 (e.g., KIQs). The user can review existing intelligence tasks 1114, modify the intelligence tasks 1114, and add new intelligence tasks 1114. An intelligence task 1114 is a simple text statement. In one embodiment, only users with a high access level are able to modify the intelligence statements 1114.

The indicators submodule 730 generates a web page where a user can see and edit indicators, such as the indicators 112 shown in FIG. 1. The indicators are clues that the user is looking for in support of an intelligence task 1114. For example, FIG. 12 is a general representation of a user interface 1200 for entering and editing indicators 1210. The user can review available indicators 1210 within the context of an intelligence task 1114 and browse through a plurality of indicators 1210. The indicators 1210 are assigned an importance 1212 (e.g., High/Medium/Low) and a weight percentage 1214.

The triggers submodule 732 generates a web page where a user can see and edit triggers. Triggers are search conditions that are applied against specific information sources. For example, FIG. 12 shows a plurality of triggers 1216 that a user can edit or add to. The triggers 1216 correspond to a particular indicator 1210. FIG. 12 also shows a source manager 1218 for defining information sources. However, triggers 1216 can be defined independently from a source so that they can be used against different sources 1218.

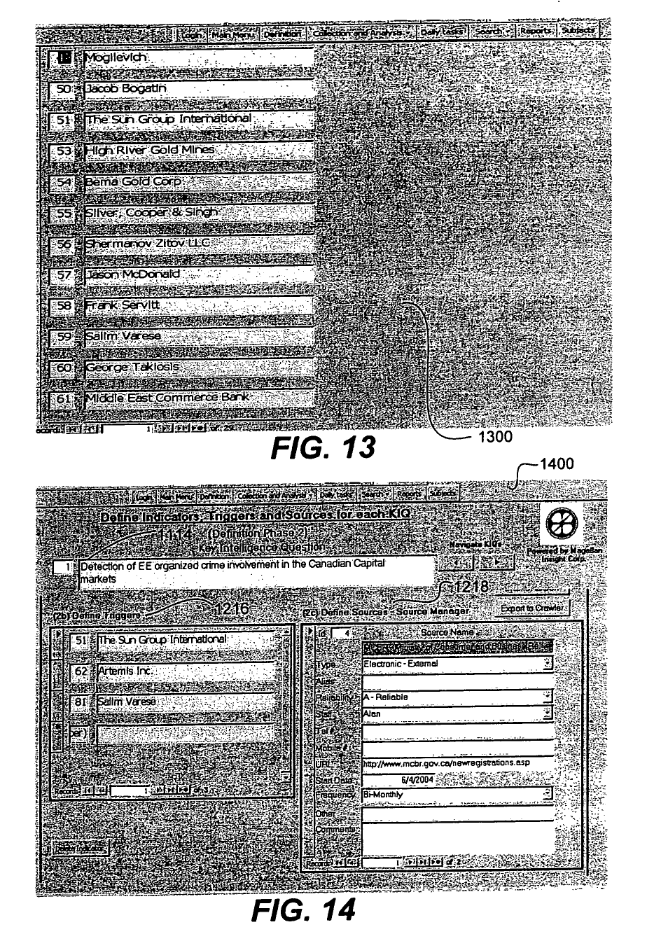

In one embodiment, independent trigger administration is managed using a general table configuration maintenance section that includes a list of all the tables that influence the behavior of the system. For example, FIG. 13 is a general representation of a user interface 1300 for a trigger administration table.

The triggers 1216 are applied against a source 1218 during the definition of a collection task within the context of an indicator 1210. The triggers 1216 can be scheduled for execution in a recurring and automatic manner. For example, FIG. 14 illustrates the user interface 1200 during a setup process for creating the collection task. In this case, the trigger 1216 is set as “The Sun Group International” and is applied against the source 1218 MCBR with a recurring bimonthly frequency starting on Jun. 4, 2004. The collection task setup supports all possible trigger/source combinations.

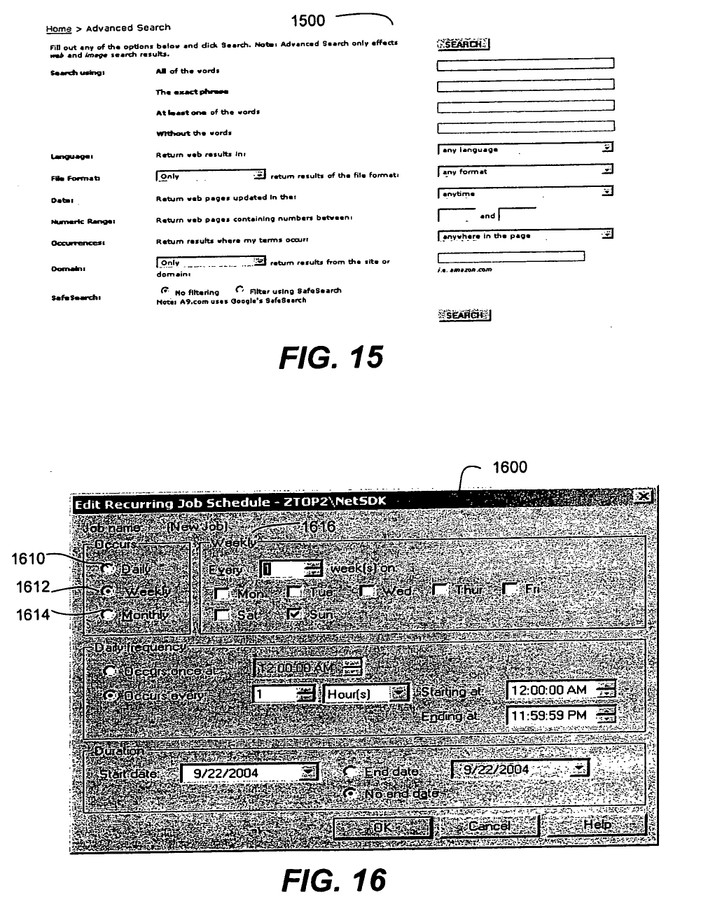

FIG. 15 is a general representation of a user interface 1500 illustrating a search using triggers to support simple Boolean operations. “All of the words” implies an AND operator between the search words. “Exact phrase” implies that the words must appear in an exact order (e.g., as one phrase). “At least one of the words” implies an OR operator between search words. “Without the words” implies a NOT operator between search words. In addition, wildcard capabilities support the SQL Full-text Indexing Engine. Thus, for example a search such as SOKOL*ICH will search for words that start with SOKOL and finish with ICH. As another example, a search for SOKOL*IC* will search for words that start with SOKOL followed by IC. In other embodiments, more intelligent searches include, for example, Google style misspelling suggestions (e.g., did you mean that you want to search for xxxx?) and/or intelligent contact type searches based on a matching name, address, or phone type of information.

Because a trigger is a search condition, it can be used both in automated collection tasks as well as searches against a source. When the user is setting up a trigger for a collection task, the user has the option of previewing the potential result space. For the case of a general repository, an internal information items, and an internal database, this results in a quick real-time search. For external source searches, this includes invoking the search engine API (e.g., Google) to see the potential universe of search results. If the results are numerous, the user may reduce the search space by adding the “Without words” search limitation until the user narrows down the search to an acceptable level. The results of the search are returned with an estimated number of hits and a first N results. Thus, the user can see what the potential issues are with setting up the information collection parameters.

For sources where the triggers in preview generate a large number of entries, the user can specify a lumping cut-off so that the individual results behave as one trigger. One alert will be generated for all of the results that arrive from the trigger. The user may dismiss the whole lump alert in one action, drill-down on the lump alert to see individual alerts, and accept or dismiss individual alerts.

In one embodiment, scheduling of recurring trigger searches is substantially similar to an SQL enterprise server scheduler. FIG. 16 is a general representation of a user interface 1600 for scheduling recurring searches or jobs. The user can specify whether a recurring search occurs daily 1610, weekly 1612, or monthly 1614. For daily 1610 based scheduling, the user can specify a gap between days (e.g., 1 day or more). The daily frequency may be adjusted down to minute resolution with a start time, an end time, and a duration having a start date and an end date. If no end date is specified, the task reoccurs for indefinitely or until the user manually changes the recurrence schedule.

For weekly 1612 scheduling resolution, as shown in FIG. 16, the user can modify weekly data fields 1616 to specify a gap between the weeks and the days of the week when the task is to be performed. For monthly 1614 frequency scheduling, the user can specify the day of the month as well as a gap between the months. Alternatively the user may select, for example, the day of the week of the n-th week of the month (e.g., the second Sunday of every month). Again, the user can specify a gap between months (e.g., the second Sunday of every other month).

C. Sources

FIG. 7C is a block diagram of the sources module 624 according to one embodiment. The sources module 624 includes a sources submodule 734, a general repository submodule 736, and a source wizard submodule 738. The sources submodule 734 allows the user to define information collection from manual sources and/or automatic search sources. Manual sources are sources where the information about a trigger is procured manually. Manual sources may include, for example, word of mouth, contact with a person, general input by an analyst or another system user, or other information sources that the user has contact with. For manual sources, the user enters alert information into the system and activates an alert using, for example, a manual collection web page.

The sources submodule 734 allows the user to automatically search a number of information sources for user specified triggers. Automatic search sources include both internal and external sources. Internal automatic search sources include, for example, internal applications accessible through an API, Internal http or https sites that include plain html pages and may or may not require authentication, internal form sites that may require posting a question in order to receive an answer, an “I-Sight” database comprising a collection of already retrieved and indexed information from various sources, and an existing internal database within an organization that may be sitting in a common relational database management system (RDBMS) and require connection setup as well as mapping of fields.

In some cases, existing internal databases may be document repositories where documents are stored in an RDBMS in binary/image format. Internal document repositories may include documents that are on shared or private drives. To perform indexing, document paths and document types are specified. Supported documents may include, for example, Microsoft Office (Word, Excel, Power Point) and PDF documents. The user may specify a drive/folder/folders as a target of the collection such that the contents of an entire specified URI are indexed.

External automatic search sources include, for example, external document repositories that are sitting on public web sites and may or may not require authentication, external http or https web sites that include plain html pages and may or may not require authentication (generally indexed by web search engines), external form sites that may require posting a question in order to receive a result and may require a form submission, external databases that may be accessed through web service APIs or through scrapping, and external APIs that provide a protocol for accessing the information programmatically such as through use of web services.

For internal and external sources, the user specifies connectivity information such as a user id and a password for authenticated resources, paths to the resources, or URIs. The user also specifies a scope of the information that is to be retrieved, a frequency of retrieval, one or more search terms or key words, and a specification for all or differential historical results. The system pulls the information from the specified URI, converts the information into a textual representation, stores the textual information into an SQL database, indexes the contents of the database, and returns the results using full text indexing capabilities. In some embodiments, the results are returned immediately such as in the case of a direct search for information. In other embodiments, the results are used as event initiators that activate the triggers. The searches may either activated by a scheduler for ongoing trigger searches or by the user for direct search inquiry.

As discussed above in relation to FIG. 2, intelligent agents are used in some embodiments to perform intelligent searches. The agents may reside on separate machines or on a single machine. Agent modules or applications may be implemented in a cross-platform Perl/C++ combination and communication with the rest of the framework may be through an exchange of a “job” xml definition structure with the agent applications through TCP/IP or SOAP over http. In one embodiment, the agents go to a web site, traverse the site, pull updated information, and store two versions of the information in a database. A first version is without markup and a second version is with markup so as to provide a cached version of the page that includes the reference as presented on the web site. In another embodiment, the agents include bandwidth control features and intelligent information pulling that pulls only pages that include the requested information into the database to reduce network traffic and database storage.

As discussed above, information sources may include http/https web sites, http/https form sites, network sites, databases and APIs. Http/https web sites include plain web sites that can be accessed using intelligent agent technologies. The user specifies a top universal resource locator (URL) for the web site and a scope of the web site that is to be searched. The scope may include, for example, complete link traversal within the web site, or traversal to a specific level or to just one specific page within the top URL.

In one embodiment, the user is provided with a web page that houses a Google search, or other available search engine search, so that the user can key in a search term. Once the user obtains the search results, the user may is able to select the URL, copy and paste the URL into a list of sites that are to be searched, and specify the search conditions. All documents that reside at the searched site are converted to plain text without any mark-up (e.g., for txt, html, pdf, or Microsoft Office documents) and stored in the database. The results are refreshed per a user selected frequency. If the user specifies only differential results triggers, only new or update pages that have the reference will cause a trigger to be fired. In one embodiment, the comparison is based on a last modified date provided by the web page and no semantic comparison of the text is done to see if the web page has been updated.

Form sites (e.g., LexisNexis and others) require both authentication as well as the ability to post a question in order to receive response. Thus, searching simulates what a user does in a browser when the user enters the value and presses a submit button through a programmatic http request/response process. Because each site may have different identifiers for login fields, forms, and input forms, the process is scriptable. Thus, a dynamic agent for form based sites follows a script and executes both the login and the inquiry post actions. The rest of the flow is the same as that for http/https sites discussed above

In some embodiments, the scripts comprise xml files with definitions of steps. The actual script specification may be created by a user familiar with information technology who can analyze the html page that is served by the site to see the form name and the input fields names. However, the completed script provides fast implementation of each new source. In one embodiment, the list of sources is bundled for specific industries and is pre-packaged with the application to provide easier scripting.

There are situations where the scripted searching process can fail. For example, the process may fail when the originating web site changes its forms (field ids) or output format. Thus, robust error handling is provided that notifies the user and/or a system administrator of a potential cause of the failure.

Network sites differ from the http sites in the type of protocol used for accessing the information. In many modern networks, the http protocol may be used for accessing even internal network shares by using a corresponding network URI instead of a URL (e.g., file:///C:/Magellan/test.txt). In some embodiments, the user may specify a breadth of the search (similar to the scope discussed above). Once the connectivity is established the rest of the flow is the same as that for http/https sites discussed above.

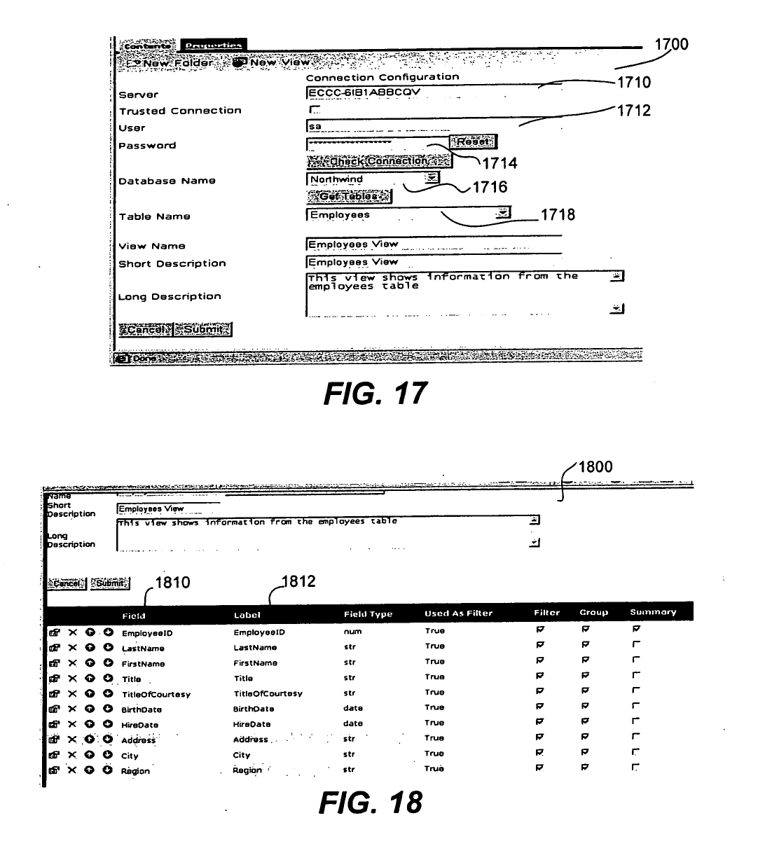

To connect to databases, the user specifies a database connection string. For example, FIG. 17 is a general representation of a user interface 1700 for specifying a database connection string by selecting options or entering data in a plurality of data entry fields.

Returning to FIG. 7C, the general repository submodule 736 allows a user to store information in a general repository. While the user can generally allocate a piece of information to an intelligence task and/or indicator, some general pieces of information may span some or all of the defined intelligence tasks or are of a generic nature. Such pieces of information are stored in the general repository. Thus, the general repository is a generic category or intelligence task wherein the processing related to the generic repository is done substantially the same way as it would be for trigger collected information. The general repository is full text indexed and the searches against internal sources also include the general repository. Adding an item to the general repository does not generate an alert.

The source wizards submodule 738 aids the user in establishing database connectivity parameters. As shown in FIG. 17, the user may specify a server name 1710, a user name 1712, and a password 1714. The user may then select an available database from a database list field 1716 and an available table from a table list field 1718. As an artisan will recognize, these data entry and parameter selection steps may be done in a separate tab employing a wizard metaphor. The user can then map from the source database into fields that are used by the system's internal database (also referred to herein as “i-Sight”). For example, FIG. 18 is a general representation of a user interface 1800 for mapping fields into an i-sight database. In this example, a field column 1810 represents fields extracted from a source database and a label column 1812 represents the mapped fields in the i-sight database.

D. Analysis

FIG. 7D is a block diagram of the analysis module 626 according to one embodiment. The analysis module 626 includes an alert submodule 740, an item list submodule 742, an item view submodule 744, a chart view submodule 746, a subjects submodule 748, a search submodule 750, a draft assessment submodule 754, a subject associations submodule 756, an assessments submodule 758, and a visualization submodule 760.

The analysis module 626 processes alerts, adds information to indicators, searches, browses, provides visualization of collected information, and assists the user I making decisions using an information hierarchy. FIG. 19 is a general representation of a user interface 1900 for collecting and analyzing information according to one embodiment. The user interface 1900 my be referred to herein as an “analysis workbench” and is part of an information processing pipeline used to trigger the generation of a draft assessment. As discussed below, in one embodiment, assessments and reports are system products. To provide the user with a better insight into the available information, the user interface 1900 includes a list view 1910, an item view 1912, and a chart view 1914. The user may control the user interface 1900 to hide or display the views 1910, 1912, 1914, as desired.

The list view 1910 includes information items displayed in a list. The user may change the size of the list and use a scroll bar 1916, if necessary, to view the listed items. An artisan will recognize that other paging mechanisms may also be provided. The items in the list may include, for example, date received, event date, source type, source, information type, importance, urgency, classification, title, and other items. To preserve screen real-estate, color coding may be used with a legend for intelligence tasks (KITs). The legend may be shown, for example, in the top right or bottom right corner of the user interface 1900 in small font to preserve space. The items' backgrounds may then be colored according to the legend.

To provide a large amount of information in the user interface 1900, icons (not shown) may be used to display, for example, source type, information type, and urgency fields. For example, source type icons may be a person symbol to represent for human information, a web symbol to represent web information, and the like. In one embodiment, the administration module 630 (discussed below) includes an option for uploading icons for corresponding entities. Default icons may also be provided.

The user can click on any of the items to get a blow-up of the item in an item page. For example, FIG. 20 is a general representation of a user interface 2000 corresponding to an item page showing collected information items 2010. The item page is a blow up of the item view with more details and more screen real-estate. Thus, larger portions of text and/or images may be displayed. The item view submodule 744 displays detailed information about the collected information items 2010. The item view may be configured to display, for example, 1 item, 2 items, 4 items, or so forth. The item view may include, for example, any images that the user has added to the item, any links to the attachment, and the original item view (e.g., marked up text, pdf, or word document).

The chart view submodule 746 displays the chart view 1914 having links of selected information items. The links are established through the trigger relationship. A single trigger may show up in different sources. Such a relationship may be shown, for example, through a link between the two sources with the title of the link being the actual trigger. All information items that are activated by the same trigger are displayed with a common link. Various pieces of information from the same source can be shown as a main page of the user interface 1900. Other smaller pages may display additional information for the page. The triggers are shown as links between the sources. An alternative view includes showing the link chart with subject associations as the links. In one embodiment, the user can select between the various views.

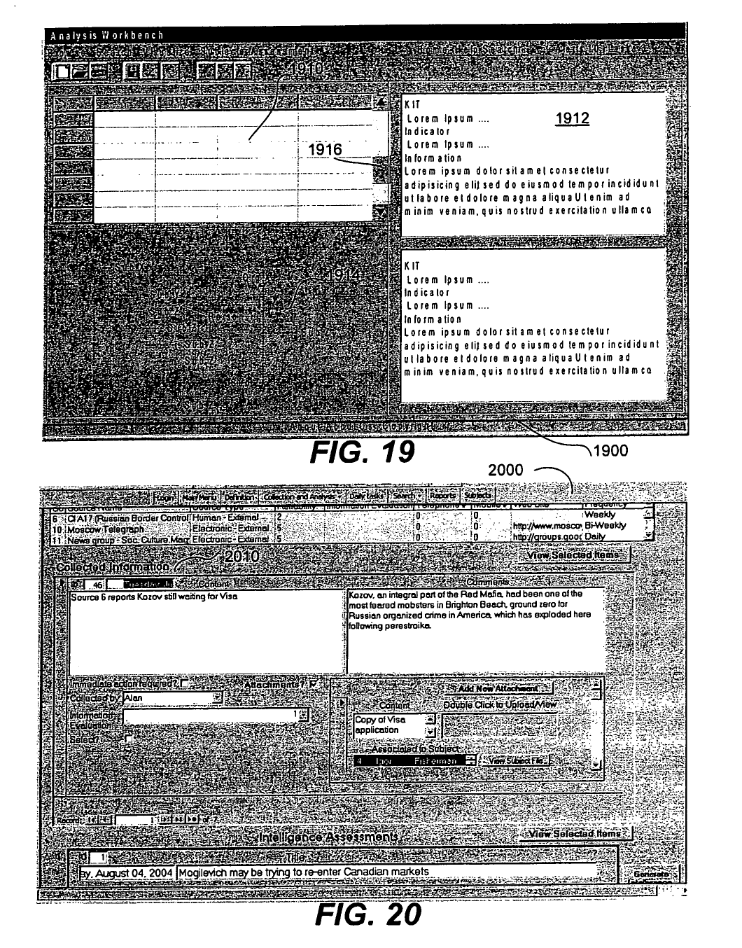

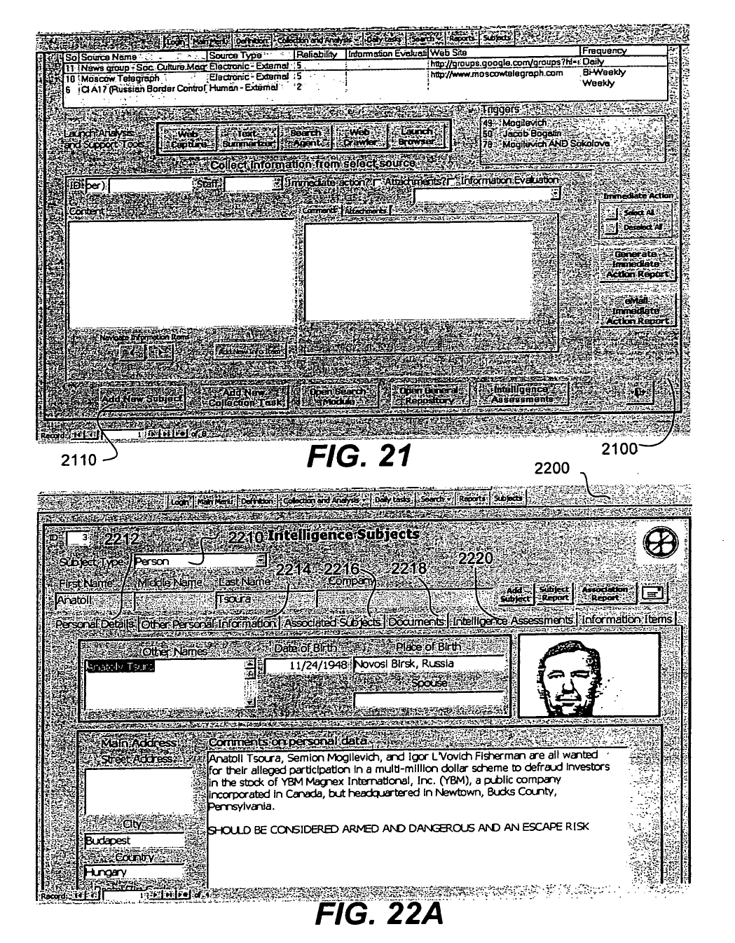

FIG. 21 is general representation of a user interface 2100 for adding information items. The user can add information items by choosing to access the user interface 2100. Further, the user is redirected to the user interface 2100 upon accepting an alert. When accepting the alert, an alert window is displayed to the user that includes the alert information that the user desires to summarize and/or copy into the information item. The alert window also includes an index of images that the user may want to add to the information item. When the user accepts the alert, the intelligence task and the indicator are automatically scheduled. However, the user may change the schedules for the intelligence task and the indicator. For new information items, the user selects from the list for the intelligence task and indicator to which the user desires to add the information item. In one embodiment, information items are added by dragging and dropping images, links, and other pieces of information from the alert page to the information item page.

As discussed above, repository items are classified under general intelligence tasks and indicators. Thus, the process of adding repository items is substantially the same as adding an information item to a particular intelligence task and indicator. The repository items can be found while doing a search in the analysis workbench. The user is able to create a new information item with the source being the repository and the trigger being the search condition that was used to find the item from the repository.

Returning to FIG. 7D, the subjects submodule 748 associates information items with one or more subjects. The subjects submodule 748 pulls in the associated subjects to the information items that are selected in the analysis workbench. In addition, the user may add subjects to the analysis workbench by selecting an add new subject button 2110 shown in FIG. 21. For a selected intelligence task and indicator, the user can browse subjects and generate subject visual linkages based on the subject associations generated by the subject association submodule 756 discussed below.

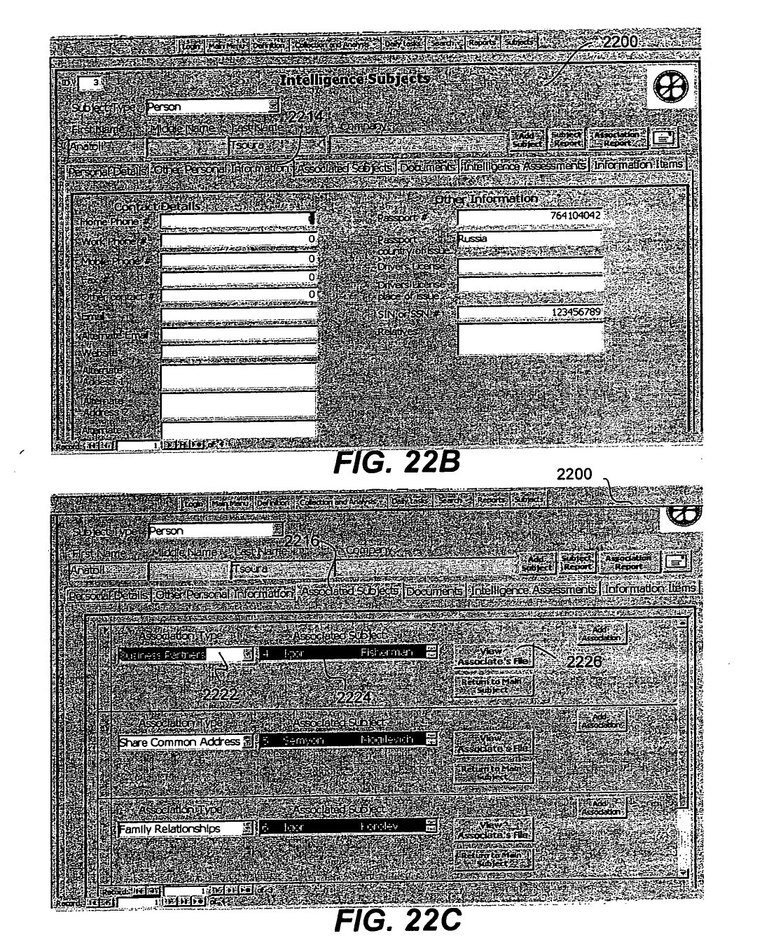

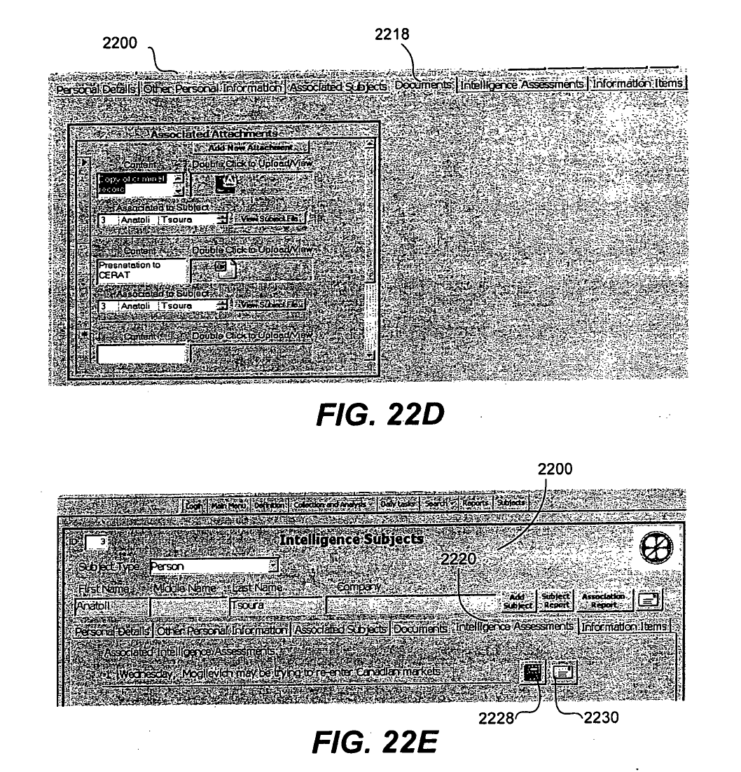

Subjects are persons, organizations and/or even non-living items (e.g. a vehicle) that are associated with information items belonging to the analytical process. FIG. 22A is a general representation of a user interface 2200 for displaying and analyzing subjects. The user can select a subject type from a subject type field 2210. The subject type, may include, for example, person, company, non-profit organization, government, address, vehicle, telephone number, website, or other type of subject. For different subject types, there are different fields that the user can enter, edit and/or review. For example, Table 3 illustrates some example fields and sub-fields that are applicable for different subject types.

TABLE 3

| | | | |
|---|---|---|---|
| person | name | first name | |
| | | middle name | |
| | | last name | |
| | | other names | |
| | gender | | |
| | date of birth | | |
| | place of birth | Country of birth | City of birth (instead of place) |
| | spouse | | |
| | address | personal address 1 | street, city, province/state, |
| | | | country, postal/zip code |
| | | personal address 2 | street, city, province/state, |
| | | | country, postal/zip code |
| | | business address 1 | street, city, province/state, |
| | | | country, postal/zip code |
| | | business address 2 | street, city, province/state, |
| | | | country, postal/zip code |
| | | other addresses | street, city, province/state, |
| | | | country, postal/zip code |
| | telephone | home 1 | |
| | | home 2 | |
| | | cell | |
| | | business 1 | |
| | | business 2 | |
| | | other | Specify type |
| | fax | personal | |
| | | business | |
| | email | email 1 | |
| | | email 2 | |
| | | email 3 | |
| | website | 1, 2, 3 | |
| | personal info | nationality | |
| | | passport # | |
| | | passport place of | |
| | | issue | |
| | | drivers licence # | |
| | | drivers license | |
| | | place of issue | |
| | | sin or ssn # | |
| | | known relatives | |
| | | finger prints # | |
| | comments | | |
| | photo | | |
| company/org. | name | main name | |
| | | other names | |
| | | operating as | |
| | | ticker symbol | |
| | address | main address | |
| | | other address 1 | |
| | | other address 2 | |
| | telephone | main # | |
| | | other # 1 | |
| | | other # 2 | |
| | fax | main | |
| | | other | |
| | website | | |
| | comments | | |
| address | location | street | |
| | | city | |
| | | state/province | |
| | | country | |
| | | postal/zip code | |
| | tennants | #1 | |
| | | #2 | |
| | | #3 | |
| | | #4 | |
| | owners | | |
| | comments | | |
| | photo | | |
| website | domain | | |
| | domain creation date | | |
| | last changed | | |
| | registration expiration | | |
| | registrant | | |
| | administrative contact | | |
| | technical contact | | |
| | domain servers | | |
| | mirror sites | | |
| | comments | | |
| tel./fax# | number | country code | |
| | | area code | |
| | country | | |
| | subscriber | #1 | |
| | | #2 | |
| | | #3 | |
| | comments | | |
| email | owner | | |
| | domain | | |
| | comments | | |
| account | number | | |
| | owner | | |
| | bank | | |
| | location | | |
| | comments | | |
| transportation | mode | vehicle | Land |
| | | marine | |
| | | aircraft | |
| | id/plate # | | |
| | owner | | |
| | province/state/ | | |
| | country registered | | |
| | model | | |
| | model year | | |
| | colour | | |
| | comments | | |
| | photo | | |

Even though subjects are not information items, according to certain embodiments, the subjects can be searched like information items. Further, the subjects can be associated with various pieces of information. Also, one subject can be associated to multiple information items. Similarly, an information item can be associated to multiple subjects.

The user interface 2200 provides easy traversal of links across both information items and subjects. A list of information items are linked to corresponding subjects. The list is similar to the list that is shown in the analysis workbench. The user can click on an information item to bring up the analysis workbench with the selected item. Clicking on one of the subjects brings up the user interface 2200 for that subject. Thus, the user can quickly cycle between the items and the subjects. Alternatively, the user can browse the link graph for the information items by subject connection.

The user interface 2200 includes a personal details tab 2212, an other personal information tab 2214, an associated subjects tab 2216, a documents tab 2218, and an intelligence assessments tab 2220. The personal detail tab 2212 includes “tombstone” data on the subject as shown in FIG. 22A. The other personal information tab 2214 includes other contact information available for the subject as shown in FIG. 22B.

The associated subjects tab 2216 includes associations between the target subject and one or more other subjects as shown in FIG. 22C. The association tab 2216 includes an association type field 2222 and an associated subject field 2224. The user can review and/or edit the association type for each associated subject. The association types may include, for example, business partners, share common address, family relationship, kind of, has, part of, connected with, married, works for, works with, lives near, mistress, related to, works near, drives, has phone number, employs, manages, registered to, seen with, uses, master, husband, brother, subsidiary, lives in, president, managing director, director, chairman, business address, beneficial owner, trading authority, shareholder, associated with, promoter, former CEO, friends, principal, address of, consultant, legal counsel, owner, may be related to, managing member, former director, manager, CFO, secretary, client, controls, signing member, CEO, VP, controlled by, subscriber, associate, or other association types.

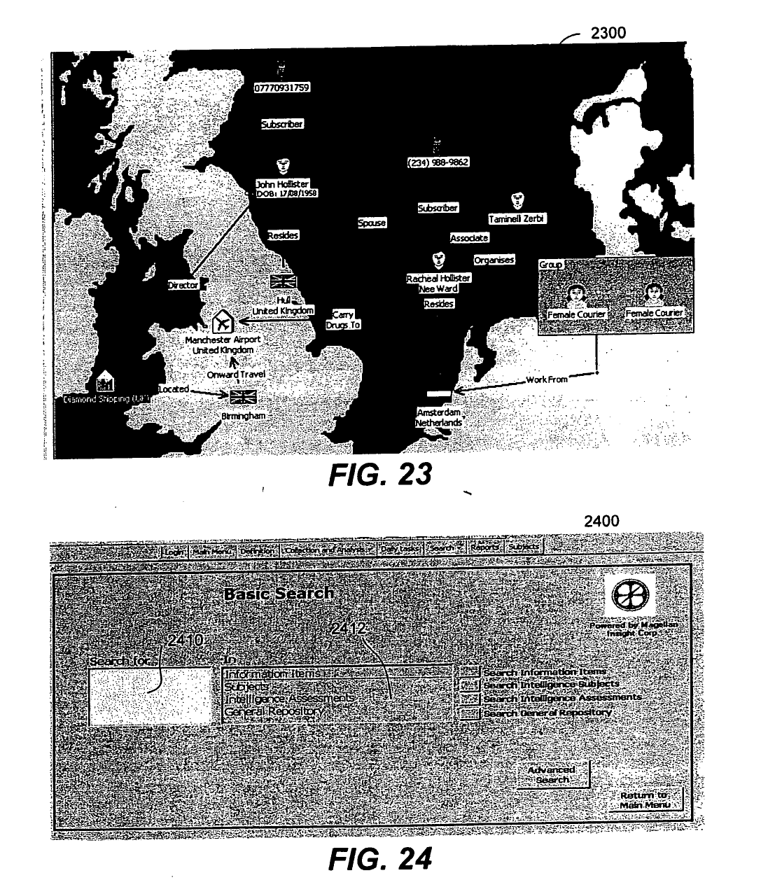

Subjects can have many associations. The user can select the associates subject file through the available link 2226. To better visualize the links between subjects, the system may generate a link graph for subject associations. For example, FIG. 23 is a general representation of a user interface 2300 for displaying a link graph of a target subject 2310 and a plurality of associated subjects. The associations are shown as links and the associated subjects are shown as items with different icons that correspond to subject types (e.g., a person icon to indicate a human, a telephone icon to indicate a subscription to telephony service, or a flag icon to indicate a related country).

The documents tab 2218 includes links to documents or actual uploaded documents for the subject as shown in FIG. 22D. Attached documents are information items but they do not live in the context of an intelligence task/indicator/trigger. Instead, the attached documents are information items associated with the subject.

The intelligence assessments tab 2220 includes a list of intelligence assessments that are associated with the subject as shown in FIG. 22E. The user can open the assessment by clicking on a report icon 2228. The user may also email multiple assessments from this page by clicking on the email icon 2230.

Returning to FIG. 7D, the search submodule 750 and the manual collection module 752 provide the searching and manual information collection functions discussed above. FIG. 24 is a general representation of a user interface 2400 for performing a “basic” search. The basic search is characterized by a minimalist approach taken in terms of the amount of information that the user needs or wants to enter. The user may only need to enter, for example, a search term in a search field 2410. Thus, in some embodiments, the user does not have to specify what he is searching in by selecting a particular item from a source field 2412. In such embodiments, all the available sources will be searched and information coming from various sources will be headlined with its corresponding source.

The search results are displayed in a view similar to the item view in analysis workbench. In one embodiment, the search results include the following information: date received, event date, source type, source, information type, importance, urgency, classification, title, and other information. The user can sort by any of the available information. The search is performed across all available cached information sources, which includes: information items, subjects, assessments, general repositories and other sources.

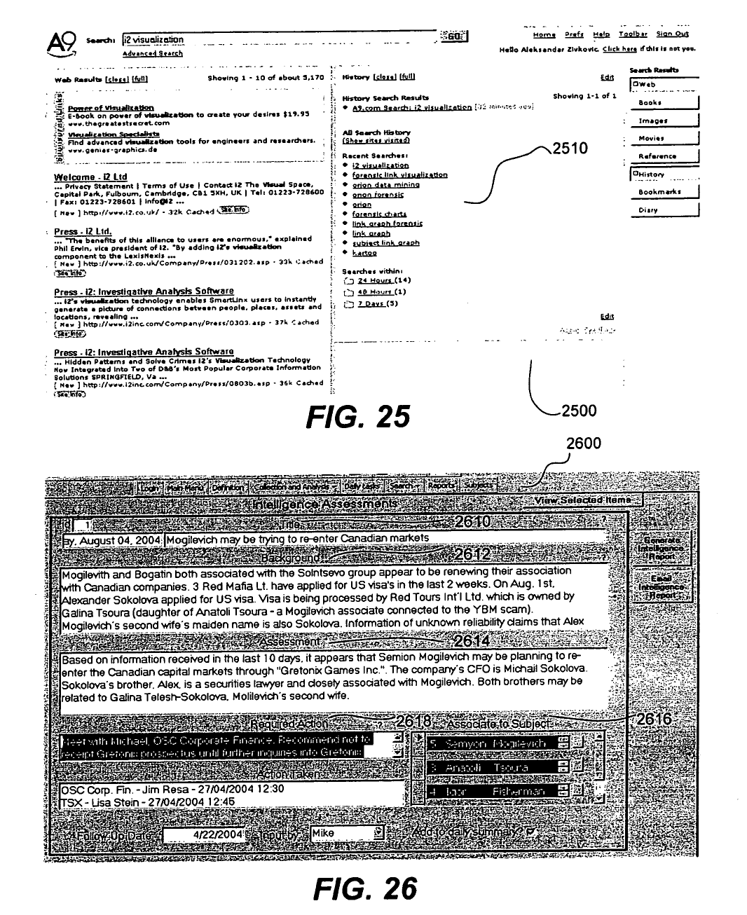

Advanced searching includes additional filters that the user can specify, such as date filters shown in FIG. 15. FIG. 25 is a general representation of a user interface 2500 for accessing search histories. The user can access a search history by clicking on a history link 2510. The history is stored for a predetermined number of days defined by the user. In one embodiment, all sources, including external sources, are available for the search and would be included as default within the search.

The draft assessment submodule 754 allows the user to quickly generate a draft intelligence assessment based on the information that is found in the analysis workbench. FIG. 26 is a general representation of a user interface 2600 for displaying draft assessment information. The draft assessment information includes a title 2610, a background 2612, an assessment 2614, associated subjects 2616, any associated tasks such as a required action 2618, and other associated information items. The required actions 2618 are tasks that are shown for allocated persons in the task bar. The assessment 2614 is created within the context of the intelligence task and the indicator.

Tasks may include, for example, follow-up actions related to the assessments 2614 or collection tasks. Tasks are displayed in the task bar of the user that is allocated the task. The tasks are also shown in the task list on the landing page. The user can open the task by clicking on its hyperlink. If the task is a manual collection task, the user is directed to a manual collection page. If the task is a follow-up task, the user is directed to the information item that required follow-up and the user will be able to mark the task as complete.

E. Visualization

FIG. 7E is a block diagram of the reports module 628 according to one embodiment. The reports module 628 provides the user with the ability to publish visualizations of subject and information link diagrams. The diagrams may be generated from an information item or a subject selection through automated import capabilities of the report module 628. In one embodiment, the user uses a local client application to open the automatically generated graph, edit the graph, and upload the modified version of the graph for publishing as part of an assessment or report.

In one embodiment, charts are information items that are stored in a special folder within the application from a functionality perspective. The charts are associated with a subject, an intelligence task, and an indicator. Charts may also be information items that are included in intelligence reports.

The reports module 628 is capable of generating several different types of reports and includes, for example, an operational reports submodule 762, an information item reports submodule 764, a subject reports submodule 766, an indicator reports submodule 768, an official reports submodule 770, and an audit reports submodule 772. The submodules 762, 764, 766, 768, 770, 772 are configured to generate the reports discussed below.

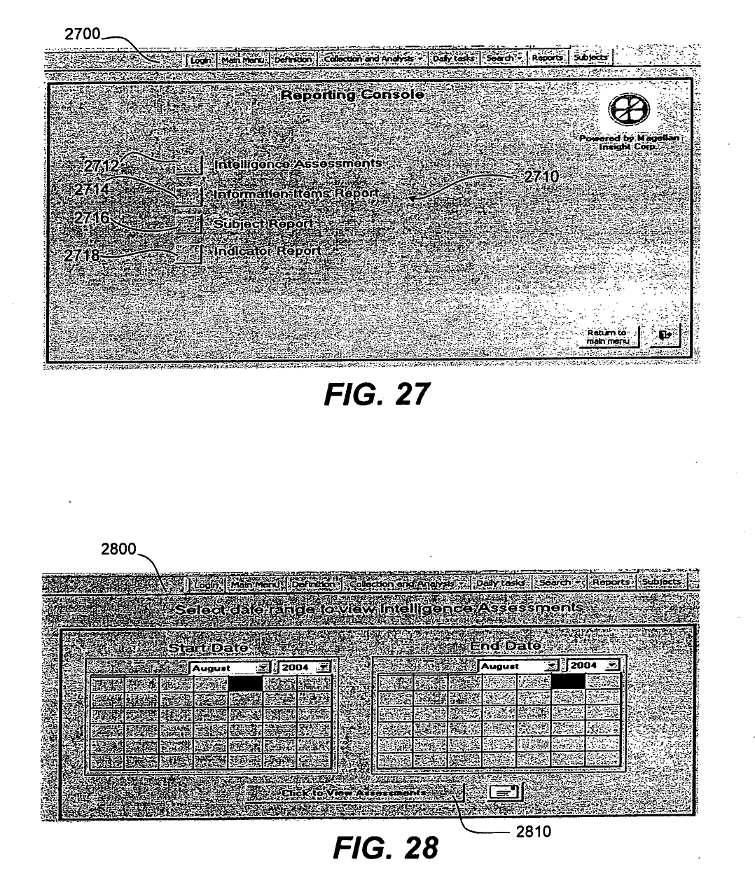

The reports module 628 separates reports into predetermined operational reports, official reports and ad-hoc reports that are generated from the results of a search. FIG. 27 is a general representation of a user interface 2700 for accessing predetermined reports according to one embodiment. The user interface 2700 includes a reports list 2710 that allows the user to select the type of operational report to generate. The reports list 2710 includes an intelligence assessments button 2712, an information items report button 2714, a subjects report button 2716, and an indicator report button 2718.

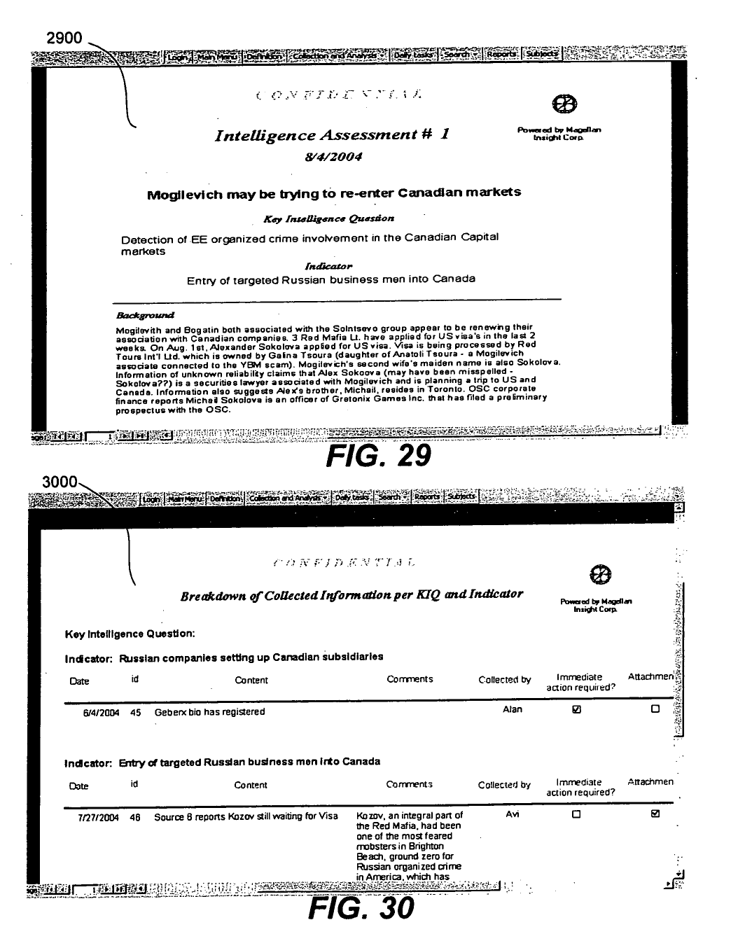

Selection of the intelligence assessments button 2712 displays the user interface 2800 shown in FIG. 28 so as to allow the user to specify a range of dates for the assessments. After specifying the start and end dates using the user interface 2800, the user selects a view assessments button 2810 to display an intelligence assessments report, such as the example intelligence assessment report 2900 shown in FIG. 29.

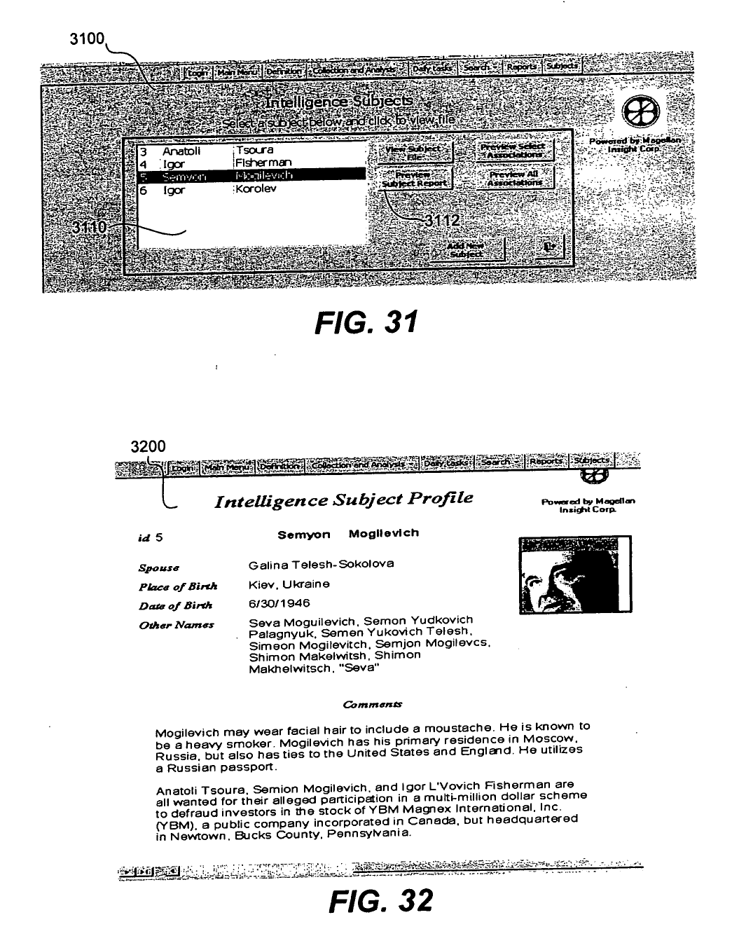

Selection of the information items report button 2714 allows the user to specify a date range for information items and generate an information items report, such as the example information item report 3000 shown in FIG. 30. Selection of the subject report button 2716 displays the user interface 3100 shown in FIG. 31 so as to allow the user to select a subject from a list 3110. After selecting a subject, the user selects a subject report button 3112 to display a subject report, such as the subject example subject report 3200 shown in FIG. 32.

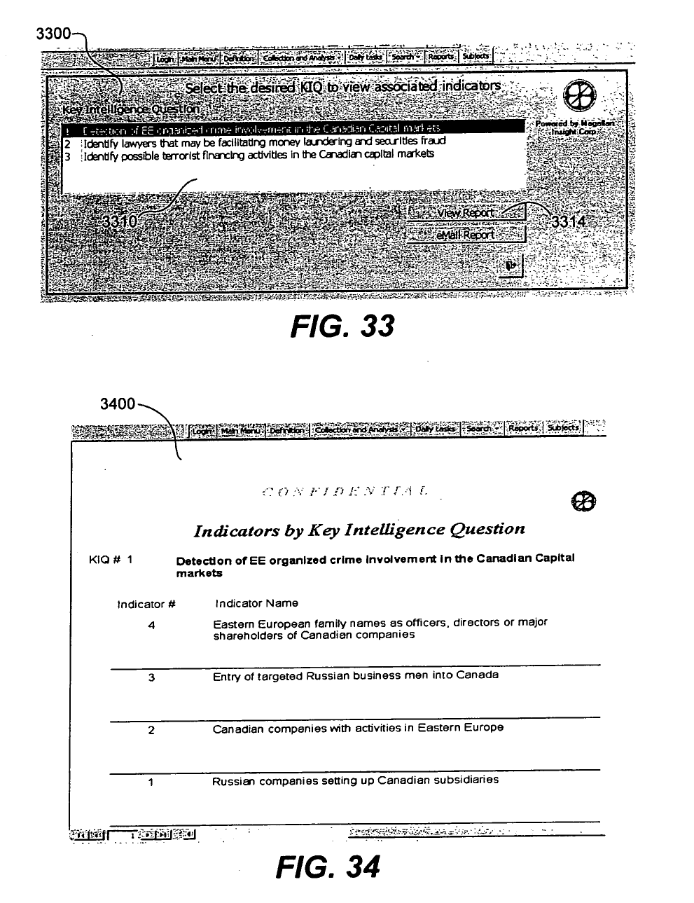

Selecting the indicator report button 2718 displays the user interface 3300 shown in FIG. 33 so as to allow the user to select an indicator from a list 3310. After selecting an indicator, the user selects a report button 3312 to display an indicator report, such as the example indicator report 3400 shown in FIG. 34.

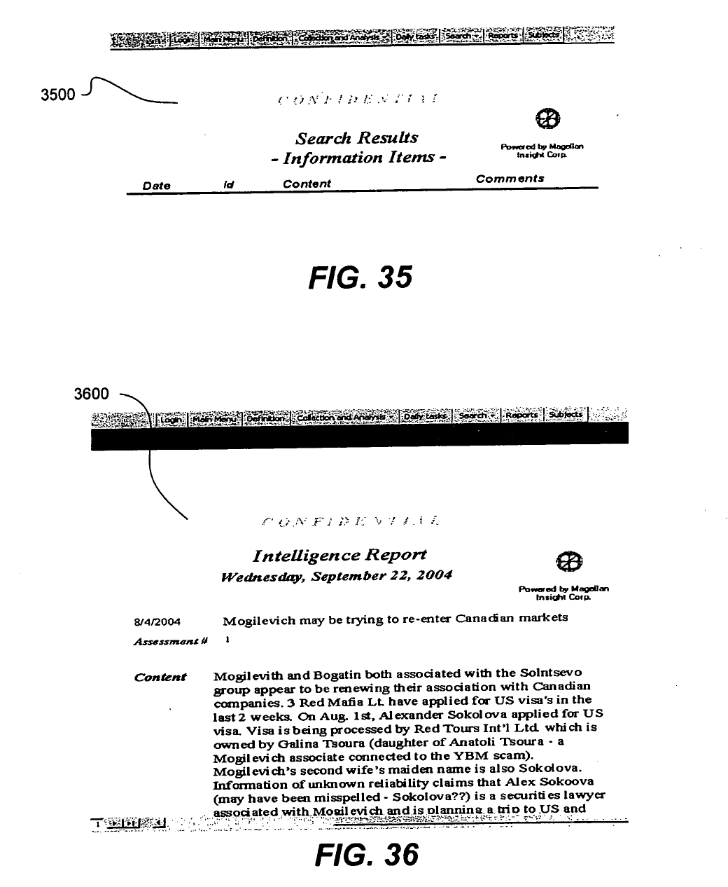

Ad-hoc reports are generated by taking the results of searches and turning them into a report. For example, FIG. 35 illustrates an example format of an ad-hoc report 3500. Official reports are generated from assessments. FIG. 36 illustrates an example of an official report 3600.

Alert management and audits are performed through running a set of reports that pull information based on actions registered for the users against the alerts. Tables that use tracking have an associated audit table that includes information such as action source, action item ID, action taken by the user, and date of action taken. In addition a final state, the fields can be tracked through current state, date created, created by and date modified, and modified by fields. These fields, in conjunction with the action table when applied to alerts, allow the user to generate reports that show when the alert was generated, what action has been taken by one or more users against the alert, and what is the final status of the alert.

Alerts can be separated by status into inactivity alerts (e.g., corresponding to inactive sources), processed alerts, and dismissed alerts. For processed and dismissed alerts, an actions report can be generated from the actions table. The audit reports are available to the report scheduler for recurring reporting. In one embodiment, audit reports are available only to members of an administrator group (e.g., includes a manager).

F. Management

FIG. 7F is a block diagram of the administration module 630 according to one embodiment. In one embodiment, the administration module 630 is only available to users who are members of an administrator group. The administration module 630 includes a tables submodule 774, a reports submodule 776, a visual tool stencils submodule 778, a skins submodule 780, a configuration files submodule 782, a users and access levels submodule 784, and an item visibility submodule 786.

The tables submodule 774 manages tables that include, for example, source types, information types, association types, indicator importance levels, and information evaluation levels. In one embodiment, the tables show up in the selection as drop-down choices. The reports submodule 776 provides reports that are available to the users in the predetermined report section to the administrator group. Thus, the administrators can upload new reports and edit existing reports without the need of recompiling the application.

The visualization tool stencils submodule 778 includes stencils for defining icons for the items that can be displayed in the link charts. An administrator, for example, can upload stencils for the users without the need of recompiling the application. The skins submodule 780 controls the colors and styles for the user interfaces. The user interface elements use styles that are defined in a central application style sheet. Administrators, for example, may modify the color schemes and style sheet properties by editing the style sheet.

The configuration files submodule 782 labels and authentication methods. For example, an administrator may modify the language used for the labels in the forms by modifying a setting in a Web.Config file for the language used. The labels are stored in resource files (e.g., xml files) with a corresponding language extension (e.g., EN for English and FR for French). The xml files can be modified for different languages. In some embodiments, the application is recompiled after modifying the xml files for different languages. The administrator may also select an authentication method by changing an option in the Web.Config file. In one embodiment, forms based authentication is used. In another embodiment, Windows authentication is used.

The users and access levels submodule 784 controls access to the system. In one embodiment, the users are registered in the system in order to gain access to the application. In one embodiment, administrators can change the users' access levels. The item visibility management submodule 786 controls the display of elements in the user interfaces.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed is:

1. A method for discovering and predicting behavior in a social network, the method comprising:
defining an information hierarchy comprising:
an intelligence task comprising an objective for collecting and analyzing information;
one or more indicators of the intelligence task; and
one or more triggers corresponding to at least one of the one or more indicators, wherein the detection of the one or more triggers indicates a likely occurrence of the corresponding one or more indicators;
automatically collecting information from one or more information sources based at least in part on the information hierarchy; and
alerting a user to the detection of the one or more triggers.

2. The method of claim 1, wherein the detected one or more triggers correspond to relationships between two or more entities corresponding to the information hierarchy.

3. The method of claim 2, further comprising displaying a social network indicating the relationships between the two or more entities.

4. The method of claim 2, wherein the relationship is a business relationship.

5. The method of claim 2, wherein the relationship is a personal relationship.

6. The method of claim 1, further comprising analyzing the information for predetermined behavior patterns.

7. The method of claim 6, wherein analyzing the information for the predetermined behavior patterns comprises detecting a combination of at least two of the triggers.

8. The method of claim 1, wherein automatically collecting the information comprises searching a database for the one or more triggers.

9. The method of claim 1, wherein automatically collecting the information comprises:
accessing a database-driven web page; and
automatically searching the database-driven web page for search terms extracted from the information hierarchy.

10. The method of claim 9, wherein automatically searching comprises generating a script that activates predetermined elements on the database-driven web page with the search terms extracted form the information hierarchy.

11. The method of claim 1, wherein at least one of the triggers comprises a predetermined entity of interest.

12. The method of claim 11, further comprising analyzing the collected information for an additional entity of interest.

13. The method of claim 1, wherein the intelligence task comprises detecting or reducing a criminal activity.

14. The method of claim 13, wherein the one or more indicators comprise indications that the entity of interest is engaged in the criminal activity.

15. A computer readable medium having stored thereon computer executable instructions for analyzing social networks, the method comprising:
defining an information hierarchy comprising at least one trigger;
automatically collecting information from one or more information sources based at least in part on the information hierarchy; and
defining a social network based upon detection of the at least one trigger.

16. The computer readable medium of claim 15, the method further comprising displaying the social network, the social network indicating the relationships between the two or more entities.

17. The computer readable medium of claim 16, wherein the relationship is a business relationship.

18. The computer readable medium of claim 16, wherein the relationship is a personal relationship.

19. The computer readable medium of claim 15, wherein defining the information hierarchy comprises defining an intelligence task comprising an objective for collecting and analyzing the information.

20. The computer readable medium of claim 19, wherein defining the information hierarchy further comprises defining one or more indicators corresponding to the intelligence task, wherein detection of the one or more indicators increases a probability of accomplishing the intelligence task.

21. The computer readable medium of claim 20, wherein the at least one trigger corresponds to at least one of the one or more indicators, wherein the detection of the at least one trigger indicates a likely occurrence of the corresponding one or more indicators.

22. The computer readable medium of claim 15, wherein automatically collecting the information comprises searching a database for the at least one trigger.

23. The computer readable medium of claim 15, wherein automatically collecting the information comprises:
accessing a database-driven web page; and
automatically searching the database-driven web page for search terms extracted from the information hierarchy.

24. The computer readable medium of claim 23, wherein automatically searching comprises generating a script that activates predetermined elements on the database-driven web page with the search terms extracted form the information hierarchy.

25. The computer readable medium of claim 15, the method further comprising generating an alert upon the detection of the at least one trigger.

26. A system for collecting information related to a social network, the system comprising:
an intelligent agent to collect information from one or more sources through a network, wherein the intelligent agent searches the one or more sources based on an information hierarchy;
a database to store the collected information;
a server to define one or more agent tasks for collecting the information; and
a controller to isolate the intelligent agent from the database and the server such that the database and the server are not accessible from the network through the intelligent agent.

27. The system of claim 26, wherein the information hierarchy comprises an intelligence task comprising an objective for collecting and analyzing the information.

28. The system of claim 27, wherein the information hierarchy further comprises one or more indicators corresponding to the intelligence task, wherein detection of the one or more indicators increases a probability of accomplishing the intelligence task.

29. The system of claim 28, wherein the information hierarchy further comprises one or more triggers corresponding to at least one of the one or more indicators, wherein the detection of the one or more triggers indicates a likely occurrence of the corresponding one or more indicators.

30. The system of claim 26, wherein the intelligent agent is further configured to search database-driven web pages for search terms extracted from the information hierarchy.

31. The system of claim 26, wherein the intelligent agent is further configured to search the collected information in the database based on the information hierarchy.

32. The system of claim 26, wherein the controller schedules execution of the agent tasks by the intelligent agent.

33. The system of claim 32, wherein the controller further reports a progress of the agent tasks to the server.

34. The system of claim 26, wherein the controller removes markups from the collected information received from the intelligent agent and stores the modified information in the database.

35. A system for analyzing a social network, the system comprising:
means for defining an information hierarchy, the information hierarchy comprising:
an intelligence task comprising an objective for collecting and analyzing information;
one or more indicators of the intelligence task; and
one or more triggers corresponding to at least one of the one or more indicators, wherein the detection of the one or more triggers indicates a likely occurrence of the corresponding one or more indicators;
means for collecting information from one or more information sources based at least in part on the information hierarchy; and
means for analyzing the information for predetermined behavior patterns based on the information hierarchy.

36. The system of claim 35, further comprising means for defining a social network comprising the analyzed information, the social network indicating relationships between two or more entities corresponding to the information hierarchy.

37. The system of claim 35, wherein the means for collecting the information is configured to:
access a database-driven web page; and
search the database-driven web page for search terms extracted from the information hierarchy.

38. The system of claim 37, wherein the means for collecting the information is further configured to generate a script that actives predetermined elements on the database-driven web page with the search terms extracted form the information hierarchy.

39. The system of claim 35, wherein the means for analyzing is configured to identify a subject of interest related to the information hierarchy.
